(19) United States
(12) Patent Application Publication
(10) Pub. No.: US 2016/0098519 A1
(43) Pub. Date: Apr. 7, 2016

(54) SYSTEMS AND METHODS FOR SCALABLE UNSUPERVISED MULTISOURCE ANALYSIS

(71) Applicant: Jorge S. Zwir, St. Louis, MO (US)

(72) Inventor: Jorge S. Zwir, St. Louis, MO (US)

(21) Appl. No.: 14/737,094

(22) Filed: Jun. 11, 2015

Related U.S. Application Data
(60) Provisional application No. 62/010,650, filed on Jun. 11, 2014.

(51) Int. Cl. G06F 19/24; G06F 19/18

(52) U.S. Cl. CPC G06F 19/24; G06F 19/18

(57) ABSTRACT

Systems and methods for identifying genetic variations in a disease and diagnosing a patient with a mental illness, or a generic variant of same. The systems and methods use genomics and phenomics in a computer-implemented methods to identify biclusters in phenomic and genomic data, discover relationships among the biclusters, organize the relations into partitions, rank the predictive utility of features, and map the disease risk function. This can in turn be used to diagnose a patient in a person-centered fashion.

### CROSS-REFERENCE TO RELATED APPLICATIONS

This application claims benefit of U.S. Provisional Patent Application Ser. No. 62/010,650, filed Jun. 11, 2014, the entire disclosure of which is herein incorporated by reference.

### BACKGROUND

1. Field of the Invention

This disclosure relates to the field of biomedical statistical analysis and modeling; more specifically, to systems and methods for a computer-implemented phenomic analysis to diagnose physical and mental illness.

2. Description of the Related Art

It has been proposed that Single Nucleotide Polymorphisms (“SNPs”) discovered by Genome-Wide Association Study (“GWAS”) account for only a small fraction of the genetic variation of complex traits in human population. The remaining unexplained variance, or missing heritability, is thought to be due to marginal effects of many loci with small effects, and has eluded attempts to identify its sources. The combination of different studies appears to resolve this problem in part. However, neither individual GWAS studies, nor meta-analytic combinations thereof, are helpful for disclosing which genetic variants explain a particular phenotype.

It is suspected that some, and perhaps most, of the missing heritability is latent in the GWAS data, which conceals intermediate phenotypes. Phenomics, defined as the acquisition of high-dimensional phenotype data on an organism-wide scale, has arisen as a possibility to address the many-to-many relationships that are inherent in the phenotype and genotype domains of a disease. However, the interaction of phenomics with genomics in human diseases is usually precluded by a reduction of dimensionality of the phenotype features, which implies the elimination of their explanatory power. Although there is an increasing interest on identifying the key phenotype features associated with the genetic variants of a disease, there is a lack of methods devoted to extract the maximum information from these descriptors.

Phenotype-genotype relations have been often established using a modest numbers of SNPs associated with limited binary or discrete case-control phenotypes in Genome-Wide Association Studies. These studies suffer from limited reproducibility, difficulties in finding causal SNPs (because tagged SNPs are not necessarily causal), and in detecting multiple genetic sources (missing heritability), and inability to detect epistatic consequences.

Recent approaches in genomics have focused on identifying functional sets of SNPs—instead of single SNPs—based on their proximity to particular genes or haplotype blocks to model the joint effect of multiple causal signals corresponding to multifaceted diseases. However, the identification of SNPs sets alone is not sufficient to explain the pleiotropic effects of the genetic variations in humans. Therefore, new methods are needed to identify, in an unbiased fashion, interpretable SNP-set structures in a broad sense, based on relations between sets of phenotype features coherently linked to SNP sets.

Further, a phenomic study of disease without a reduction in dimensionality results in a prohibitively large quantity of data to examine, such that for even a trivial analysis, conclusions would not be available during the patient's life time, much less during a meaningful diagnostic window. This in turn makes it difficult to prescribe a treatment or therapy, particularly for diseases responsive to early intervention. To uncover latent information, a computer-implemented method is needed.

It should be further be noted that in a diagnostic setting, both physical and mental illness can be difficult to diagnose, and is often diagnosed in a trial-and-error manner based upon criteria evaluated from reporting performed by non-physicians or untrained observers, such as teachers, relatives, or the patient. Distinguishing one disease from another is often difficult in such settings, as other, perhaps unrelated, disorders may obscure key indicators or present irrelevant indicators that result in false positives. This can result in patients being placed on a series of therapies (pharmaceutical and otherwise), and the patient is then observed to determine whether reporting (e.g., DSM) criteria change and, if no substantial change is observed or reported, trying another therapy. This can result in delayed treatment, unnecessary pharmaceutical exposure, and increases demand for scarce and expensive health care services.

Thus, while GWAS has emerged as a method for identifying genetic variants associated with the risk of a disease, this approach has practical limits with complex diseases, such as mental illnesses like schizophrenia, where more than 1,000 genes may be implicated. Existing analyses of genetic, imaging, biomarkers and clinical studies only provide disjoint results or associations, and are only based on a few independent variables. Investigators do not pay as much attention to the phenotype as to the genotype or image analysis. The results of a study are often expressed as statistical measures focused on distinguishing patients from controls; however, they do not provide knowledge about groups of patients sharing particular features in a networking framework, where these groups can be structurally organized.

Moreover, associations are often based on preconceived knowledge, concealing the opportunity for novel, data-driven discoveries. The available resources consist of databases based on text mining the literature instead of direct access to the studies. Physicians can only remember limited and/or partial information about their academic training and experience in previous diagnosed cases in the short time of the appointment with the patient. A solid diagnostic assessment based on [genetics×imaging×clinical manifestations×biomarkers×drug treatments×environmental/behavioral factors] interactions is not available.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method of displaying the risk surface of a disease comprising: providing a study database comprising numeric study data about a plurality of subjects in a study of the disease; providing a phenomic database comprising phenotype data about a plurality of phenotype features of the plurality of subjects in the study of the disease; identifying in the phenomic database a first bicluster set comprising plurality of phenotype biclusters in the received phenomic database; identifying in the study database a second bicluster set comprising plurality of study data biclusters in the study database; discovering a plurality of phenotype-study data relations between the first bicluster set and the second bicluster; organizing the discovered plurality of phenotype-study data relations into a plurality of partitions; organizing the plurality of discovered phenotype-study data relations in each partition in the plurality of partitions into one or more topological networks; ranking the predictive utility of each one of the phenotype features; generating a risk surface for the disease using the phenotype as an x-dimension, the study data as a y-dimension, and a calculated risk dimension based upon the predictive utility of each one of the phenotype features as a z-dimension, each one of the calculated risk dimensions being a point on the generated risk surface; and displaying the generated risk surface to a user.

In an embodiment of the method, the disease is a mental illness.

In an embodiment of the method, the mental illness is schizophrenia.

Also described herein, among other things, is a method of displaying the risk surface of a mental illness comprising: providing a genomic database comprising numeric genotype data about a plurality of subjects in a study of the mental illness; providing a phenomic database comprising phenotype data about a plurality of phenotype features of the plurality of subjects in the study of the mental illness; receiving, by a computer server over a data communications network, a copy of the genomic database and a copy of the phenomic database; the computer server identifying in the received phenomic database a first bicluster set, the first bicluster set comprising plurality of phenotype biclusters in the received phenomic database, the identification using a factorization algorithm; the computer server identifying in the received genomic database a second bicluster set, the second bicluster set comprising plurality of genotype biclusters in the received genomic database, the identification using the factorization algorithm, the computer server discovering a plurality of phenotype-genotype relations between the first bicluster set and the second bicluster set by calculating the pairwise probability of intersection between the first bicluster set and the second bicluster based at least in part upon the calculation of a Ri,j distribution statistic; after the calculating step, the computer server organizing the discovered plurality of phenotype-genotype relations into a plurality of partitions by: calculating the distance matrix among all phenotype-genotype relations in the discovered plurality of phenotype-genotype relations, the distance matrix being calculated based at least in part upon the calculation of a Ri,j distribution statistic; and clustering the discovered plurality of phenotype-genotype relations based at least in part upon the calculated distance matrix, each one of the clusters being a partition in the plurality of partitions; the computer server organizing the plurality of partitions, the organizing comprising, for each partition in the plurality of partitions: optimizing the each partition, the optimizing comprising, for each phenotype-genotype relation in the discovered plurality of phenotype-genotype relations in the each partition, removing the each phenotype-genotype relation from the each partition if the each phenotype-genotype relation is redundant, the redundancy of the each phenotype-genotype relation being based upon the computer server determining whether a Ri,j distribution statistic calculated for the each phenotype-genotype relation is below a predefined threshold; and after the optimizing step, organizing the remaining plurality of discovered phenotype-genotype relations in the each partition into one or more topological networks; after the organizing step, the computer server ranking the predictive utility of the phenotype features, the ranking comprising, for each optimized partition in the plurality of partitions: for each remaining relationship in the plurality of discovered phenotype-genotype relations in the each optimized partition: labeling each subject in the each remaining relationship with one of two categorical class labels for the each relationship; labeling each subject not in the each remaining relationship with a second of the two categorical class labels for the each relationship; calculating a first decision tree ranking the feature utility, the first decision tree based at least in part on the phenotype database; and calculating a second decision tree ranking the feature utility, the second decision tree based at least in part on the genotype database; the computer server generating a visualization of the risk surface of the mental illness, the generation comprising, for each optimized relation in each partition in the plurality of optimized partitions: forming a 3-tuple for the each relation, the formed 3-tuple comprising: a phenotype dimension; a genotype dimension; and a risk dimension calculated at least in part from the weighted average of the epidemiological risks of all subjects in the each relation; the computer server generating a computer-displayable image, the computer-displayable image comprising data which, when displayed by a computer, displays a projection of a three-dimensional graph projected on a two-dimensional plane, the three-dimensional graph comprising: an x-axis corresponding to the phenotype dimension; a y-axis corresponding to the risk-dimension; and a surface generated from the formed 3-tuples and plotted on the graph such that for each of the formed 3-tuples, the risk dimension is a point on the surface; and displaying the generated computer-displayable image to a user.

In an embodiment of the method, the mental illness is schizophrenia.

In an embodiment of the method, the factorization algorithm is a non-negative matrix factorization (“NFM”) method.

In an embodiment of the method, the non-negative matrix factorization method is selected from the group consisting of the bioNFM method and the fuzzy NFM (“FNMF”) method.

In an embodiment of the method, the factorization algorithm is selected from the group consisting of: the Cheng and Church method; the FABIA method; and, the FLOC method.

In an embodiment of the method, all Ri,j distribution statistics (“PIhyp”) are calculated using the equation

$${PI}_{hyp} ( {P}_{i} , {G}_{j} ) = 1 - {\sum }_{q = 0}^{p - 1} ( \begin{matrix}h \\ q\end{matrix} ) ( \begin{matrix}g - h \\ n - q\end{matrix} ) / ( \begin{matrix}g \\ h\end{matrix} ) \begin{matrix}h = \vert {P}_{i} \vert \\ n = \vert {G}_{j} \vert \\ p = {P}_{i} ⋂ {G}_{j}\end{matrix}$$

wherein p observations belong to a set Pᵢ of size h, and the p observations also belong to a set Gⱼ of size n; and wherein g is the total number of observations.

In an embodiment of the method, in the organizing the plurality of partitions, after the optimizing step, the organizing the remaining plurality of discovered phenotype-genotype relations in the each partition into one or more topological networks is performed by the computer server using a statistical method for comparing similarity or diversity of sample sets.

In an embodiment of the method, the statistical method for comparing similarity or diversity of sample sets uses a Jaccard similarity coefficient.

In an embodiment of the method, the step of the computer server identifying in the received phenomic database a first bicluster set, the first bicluster set comprising plurality of phenotype biclusters in the received phenomic database, the identification using a factorization algorithm is performed independently of the step of the computer server identifying in the received genomic database a second bicluster set, the second bicluster set comprising plurality of genotype biclusters in the received genomic database, the identification using the factorization algorithm.

The method of claim 4, wherein the computer server limits the number of biclusters in the first bicluster set to a quantity no greater than the square root of the number of subjects represented in the phenomic database.

In an embodiment of the method, the computer server limits the number of biclusters in the second bicluster set to a quantity no greater than the square root of the number of subjects represented in the genomic database.

In an embodiment of the method, the computer server comprises a web server.

In an embodiment of the method, the method further comprises: before the displaying step, the web server causes the generated computer-displayable image to be transmitted over the data communication network to a client computer; and the displaying the generated computer-displayable image to a user comprises the client computer displaying the received generated computer-displayable image to a user of the client computer.

In an embodiment of the method, the method further comprises: the computer server analyzing the statistical significance of at least some of the discovered relations to the mental illness, the analyzing comprising, for each optimized relation in each partition in the plurality of optimized partitions: supervising the relation; after the supervising step, the computer server performing an association test on the each optimized relation.

In an embodiment of the method, the association test is a statistical regression test.

In an embodiment of the method, the statistical regression test is a kernel-machine regression test.

In an embodiment of the method, the kernel in the kernel-machine regression test is an identity-by-state kernel.

### BRIEF DESCRIPTION OF THE DRAWINGS

FIGS. 1A-1C provides an embodiment of the workflow of an embodiment of a SUMA web server.

FIGS. 2A-2D provide a synthetic example designed to compare the ability of the bioNMF and FNMF methods to identify pre-defined crisp biclusters.

FIGS. 3A-3F provide a synthetic example designed to compare the ability of the bioNMF and FNMF methods to identify pre-defined biclusters with partitions harboring outliers (empty).

FIGS. 4A-4F provide a synthetic example designed to compare the ability of the bioNMF and FNMF methods to identify pre-defined biclusters with partitions harboring fuzzy/overlapped biclusters.

FIGS. 5A-5S provide a synthetic example designed to compare the ability of the bioNMF and FNMF methods to identify pre-defined biclusters with partitions harboring different number of maximum biclusters (k), from 2 to 5.

FIG. 6 provides a genome-wide probability of the relations.

FIG. 7 depicts an embodiment of a method for preparing input files for use by the systems and methods.

FIG. 8 depicts a schematic of the logical for a platform for diagnosis of mental diseases.

FIGS. 9A-9B depicts a schematic of another embodiment of an implementation of the platform for diagnosis of mental diseases depicted in FIG. 8.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Described herein, among other things, is a computer that implements phenomics to identify SNP-set structures in a broad sense, i.e., causally cohesive genotype-phenotype relations. Generally, these relations are agnostically identified, without considering disease status of the subjects, and organized and displayed in a user-interpretable fashion. By incorporating a posteriori the subject status within each relation, the risk surface of a disease may be established in an unbiased mode. It is generally contemplated that this approach will serve as a complement to other analysis methods. This mode of analysis is generally referred to as scalable unsupervised multisource analysis, or “SUMA” for short. References herein to a “SUMA server” or “SUMA computer” describe a computer system (e.g., hardware) implementing the analysis described herein as software. An embodiment of a server implementing the systems and methods described herein is the PGMRA web server publically available at http://phop.ugr.es/fenogeno, the entire disclosure of which is herein incorporated by reference. While this disclosure is generally made with respect to a client-server architecture, it should be noted that the systems and methods could be implemented locally on a computer system without the use of network communications, such as standalone software.

The PGMRA server above is a computer hardware system which implements in SUMA software the methods described herein in a conceptual framework for dissecting a GWAS study into coherent many-to-many phenotype-genotype relations. However, it should be noted that any type of measured data, including waveforms, time series, images, streaming data or real time data, can be used in conjunction with the systems and methods described herein, and the techniques are not restricted to GWAS studies. It should also be noted that the systems and methods described herein are not limited to mental illnesses, but rather may be applied to physical illnesses and comorbidities, or interactions, among illnesses.

The relations capture and encode multifaceted data interactions and, organized as a network, provide a snapshot of what is effectively a single GWAS experiment, or multiple GWAS experiments or other types of data. The results are generally provided in an interpretable graphical fashion.

Throughout this disclosure, the term “diagnosis” and its variants should be understood to generally mean person-centered diagnosis, particularly with respect to mental illnesses.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “real time” generally refers to software performance and/or response time within operational deadlines that are effectively generally cotemporaneous with a reference event in the ordinary user perception of the passage of time for a particular operational context. Those of ordinary skill in the art understand that “real time” does not necessarily mean a system performs or responds immediately or instantaneously. For example, those having ordinary skill in the art understand that, where the operational context is a graphical user interface, “real time” normally implies a response time of about one second of actual time for at least some manner of response from the system, with milliseconds or microseconds being preferable. However, those having ordinary skill in the art also understand that, under other operational contexts, a system operating in “real time” may exhibit delays longer than one second, such as where network operations are involved which may include multiple devices and/or additional processing on a particular device or between devices, or multiple point-to-point round-trips for data exchange among devices.

Throughout this disclosure, the term “database” generally refers to an organized collection of data. A typical database is implemented generally as a logical or physical file, or collection of such files. Typically, users interact with databases indirectly through database management software, which is also commonly referred to in the art as “the database.” Database software includes, but is not limited to, MySQL, PostgreSQL, Microsoft SQL Server, Oracle, Sybase, DB2, and other database software. The particular structure and format of a given database is generally relevant only to the extent that client software accessing the database without the benefit of database software must be capable of parsing and processing the data, which generally requires a data definition or other basis for understanding the structure of the database as input. For sake of clarity and avoidance of doubt, the term “database” as used herein generally means the data itself, regardless of format.

One of ordinary skill in the art will understand and appreciate that, depending on context and usage, a reference to a “database” may imply or require the use of database management software and may include the use of “big data” services and technologies, such as, but not necessarily limited to, cloud storage. By way of example and not limitation, where software is described as “searching the database,” one of ordinary skill in the art would generally assume that a search is conducted indirectly by submitting commands to database management software which in turn manipulates the database and provides results. By way of contrast, where software is described as receiving and processing a database file, one of ordinary skill in the art would generally assume that such software does not use intermediate database management software but rather is programmed to act directly upon the database itself.

One of ordinary skill in the art will further understand, upon reading this disclosure, that the systems and methods described herein integrate multisource data into structural clusters that facilitate classification of discrete observations and regression on continuous values in support of diagnostic, prognostic and recommendation systems. The data thus generally reflects identification of critical features and identification of critical observations, where criticality is assessed in the judgment of the physician or study coordinator.

Throughout this disclosure, the term “clustering” refers generally to the meaning of the term field of statistics and exploratory data mining, and particularly to the task of organizing a set of objects into two or more groups, or “clusters,” wherein all members of each cluster are more similar to each other than to those in other clusters. In computer science, “clustering” generally means, given n samples represented by a p-dimensional feature set, the dataset may be represented by a n×p matrix M, with rows indicating samples and columns indicating features, such that Mᵢⱼ expresses feature j for sample i. M may then be manipulated by an algorithm to assign each of the n samples to one of two or more clusters or groups. Similarly, throughout this disclosure, the term “biclustering” refers generally to the above concept with respect to both columns as well as rows. It will be appreciated by one of ordinary skill in the art that, after re-ordering the rows of M to group members of each cluster together, the discovered relations become evident, particularly when data visualization techniques are applied.

At a high level, a SUMA web server implements, in computer software, systems and methods that conduct exploratory data mining to independently identify SNP sets and phenotype sets from GWAS data, uncovering many-to-many phenotype-genotype relations. The methods may also organize the uncovered coherent relations as networks in an interpretable topological fashion that, in turn, describes the risk surface of a disease. The methods are generally generic, and can concurrently perform exploratory and explanatory analyses of the phenomic and genomic domains of genome-wide data, uncovering latent intermediate phenotypes in the sample.

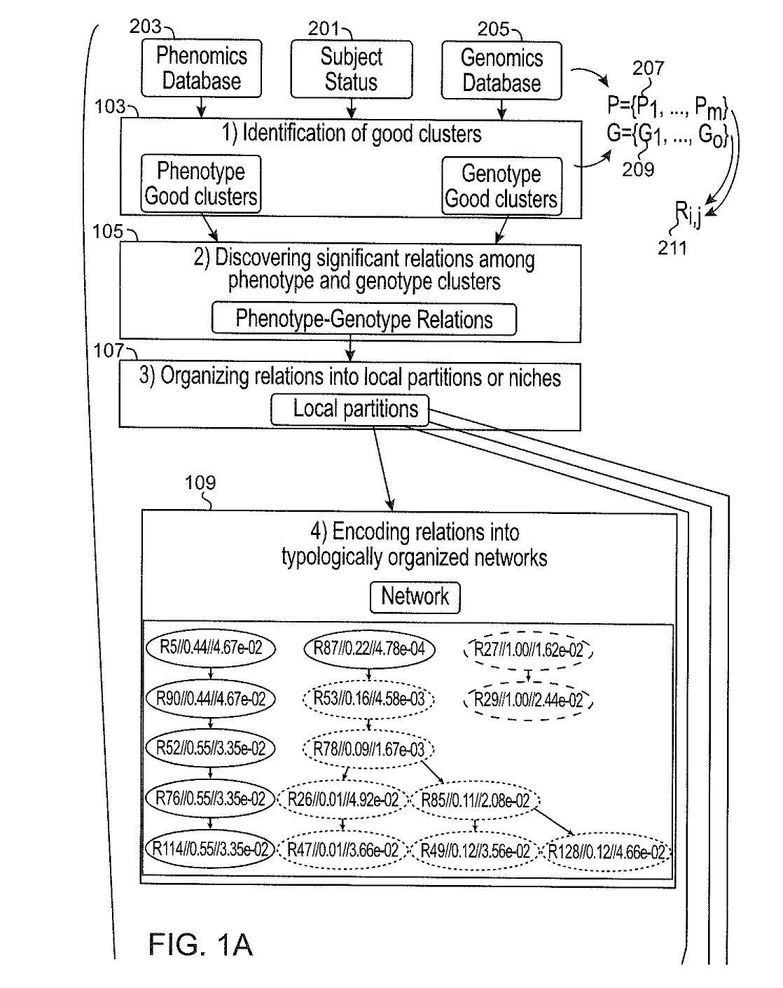

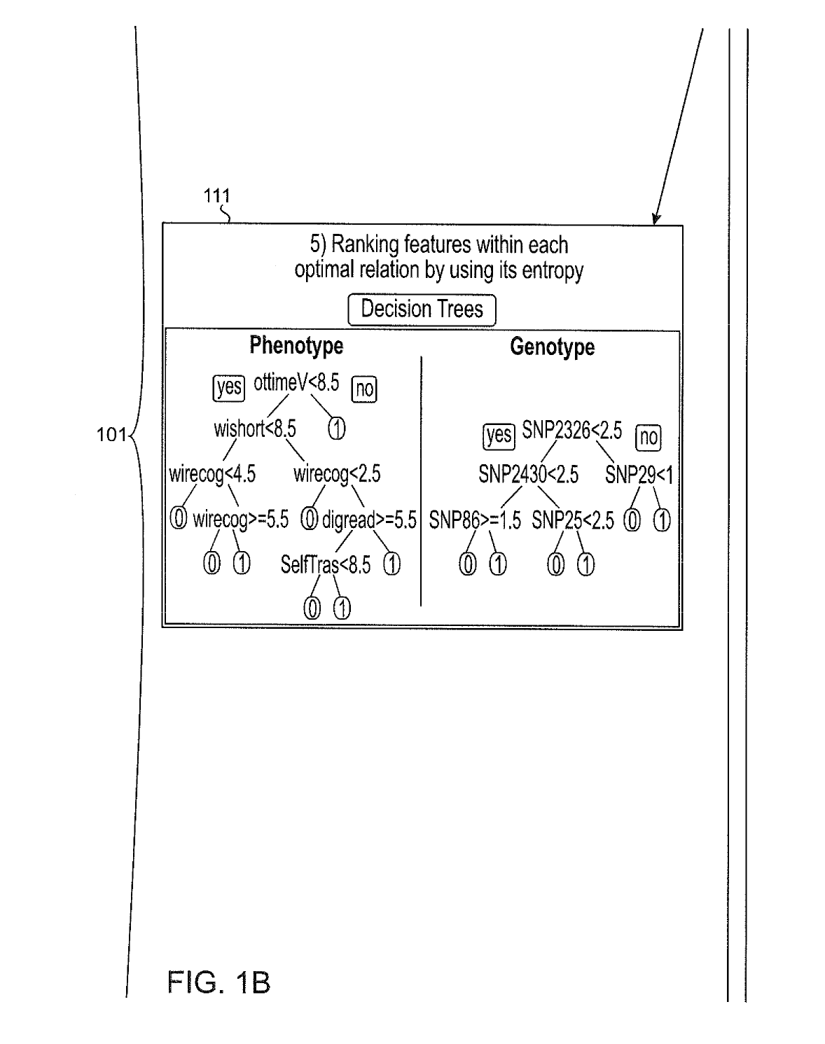

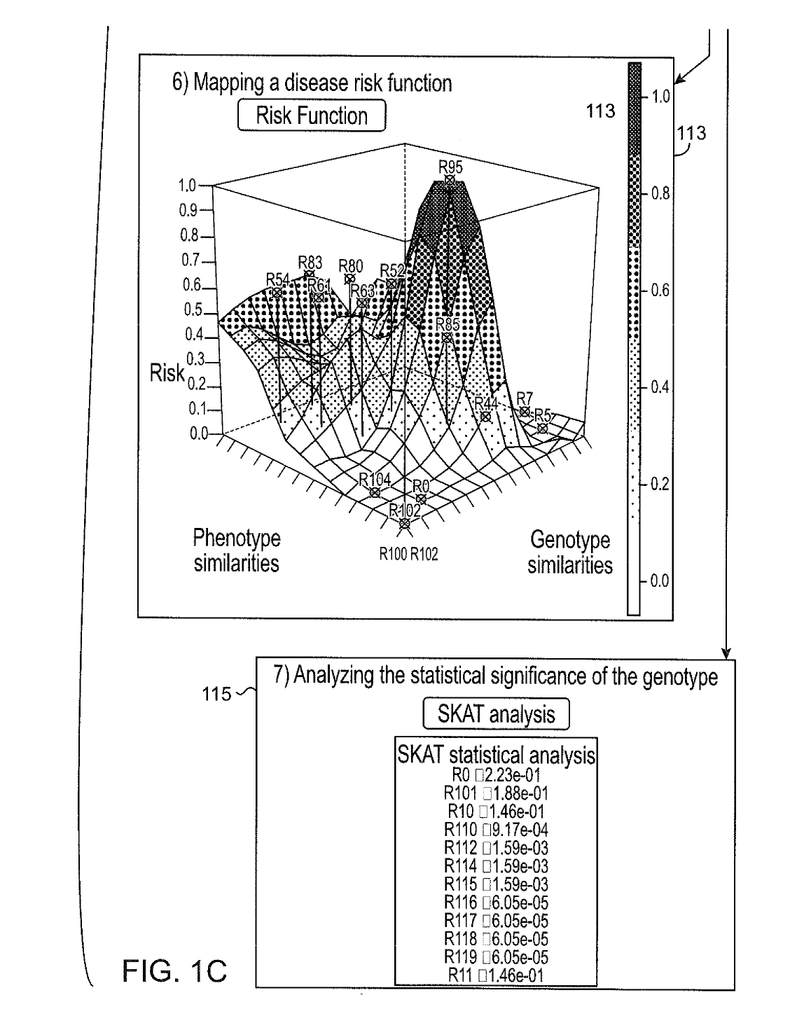

FIG. 1 depicts an embodiment of a method (101) for carrying out the analysis described herein. At a high level, the depicted embodiment (101) comprises seven steps: identification from source data of the sets of clusters on which the method will operate (103); discovering significant relationships among the clusters in the identified sets (105); organizing the relationships into local partitions, or “niches” (107); encoding relations into networks (109; tanking features (111); mapping a disease risk function (113); and statistical analysis (115).

Generally speaking, the method of FIG. 1 is implemented as computer software, typically in a client-server architecture. The depicted embodiment contemplates the use of a web server. It will be understood by one of ordinary skill in the art that web server software generally handles data communications using web protocols, and technologies built on top of such protocols, but the software performing the method described herein may be implemented via one or more separate, standalone programs. Alternatively, the software implementing the method may be a customized web server which implements the appropriate web protocols. In a still further alternative, the software may implement the method as a standalone program or application, or suite of applications or programs, which are run locally. In a still further alternative, the software implementing the method may be, in whole or part, a module, plug-in, add-on, or other third party extension of a web server. One of ordinary skill in the art will appreciate that these and other implementations are contemplated by this description.

In the depicted embodiment, user interfacing elements of the method are generally implemented through the web client/server model (i.e., a web page or web site), comprising user interface components that can be viewed and/or manipulated by the user to provide the inputs used by the system (described in more detail below) and view, access, or download the outputs of the system (e.g., status reporting, final results, etc).

As indicated in the depicted method of FIG. 1, identification from source data of the sets of clusters on which the method will operate (103) generally uses three inputs: a phenomics database (203), a genomics database (205), and a subject status file (207). These databases and files are generally in a format which the SUMA server software is programmed to understand, parse, and process. By way of example and not limitation, databases (203) and (205) are typically, but not necessarily, file-based databases, such as symbol-delimited or symbol-separated matrices. Also by way of example and not limitation, one or both of databases (203) and (205) may be tab-separated matrices organized into a flat file or text file. The input file format for any particular SUMA implementation may vary, and, for sake of simplicity, the format for any implementation will be referred to herein as a “SUMA” format or “SUMA-compliant” format.

Genomics database (205) generally comprises information about the genotype variables of each subject in a given study in numeric format. In the depicted embodiment, the SNP alleles are represented by a combination of numeric values (e.g., 1=AA, 2=AB, 3=BB and 0=missing value). Phenomics database (203) generally comprises information about the phenotype features (i.e., the p-dimensional feature set) and subjects for a given study. It is preferable that feature values in the phenomics database (203) be normalized between the minimum and maximum values of each feature, either as they appear in the phenomic data or on a standard scale or spectrum. By way of example and not limitation, when encoding a GWA study of schizophrenia, 8007 SNPs are used. However, it is possible and sometimes preferable to use a pre-selection of SNPs with relaxed p-values, such as by using PLINK (discussed below) for larger samples. Further, it should be understand that the systems and methods described herein are not limited to this figure and it is specifically contemplated that many more SNPs could be used, ranging into the millions or more.

In the depicted embodiment, the databases (203) and (205) are provided by the user. In an alternative embodiment, the user may provide a link, URL, or other computer-understandable address to identify a networked resource where the input files can be found.

As described above, phenomics database (203) generally is the structure of a matrix, though the particular format may vary (i.e., tab-separated vs. comma-separated vs. fixed-space delimited, etc.). In the typical arrangement, features are the rows and subjects are columns, but in alternative embodiments, other structures are possible. One of ordinary skill in the art will appreciate that the web server will understand the structure of the phenomics database (203), such as by being programmed to assume a particular SUMA format, or by being provided with a data definition file that describes the format of the input files, particularly where the structure of a specific input file does not conform to a default SUMA format.

The subject status file (e.g., case or control) generally comprises, among other things, data for converting, translating, or understanding the status classification, typically using numeric values mapped to the status (e.g., 1=case, 2=relative, and 3=control).

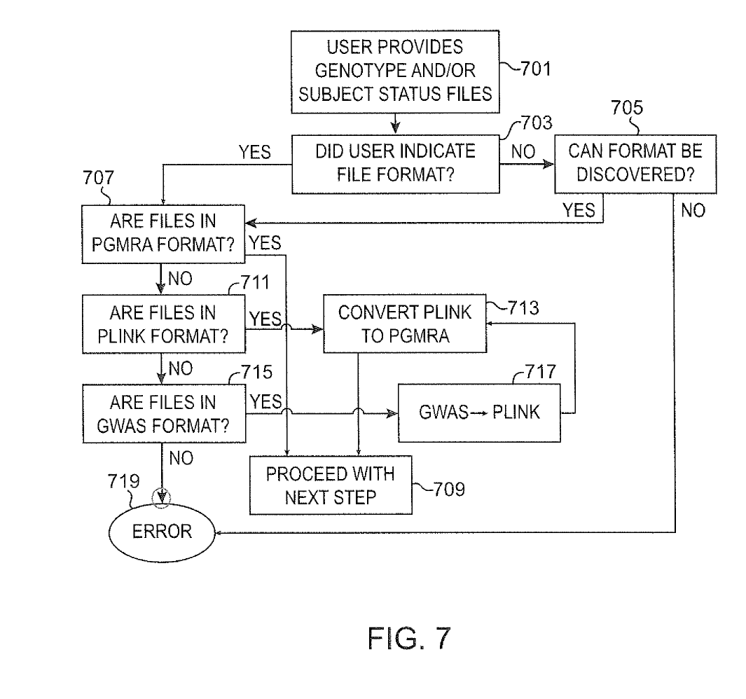

In an embodiment, the genotype (205) and subject status files (201) are generated from standard files used by or produced from third party tools. For example, PLINK files may be converted to appropriate format for input to a SUMA web server. An example of this program logic is depicted in FIG. 7. In the depicted embodiment, the user provides genotype and/or subject status files (701) and may optionally provide an indication of the file format (703). Alternatively, the file format may be automatically discovered (705) using techniques now known or in the future developed in the art, such as examining file extensions, file headers, and record length. If the files provided are already in SUMA format (707) then the system may simply proceed to the next step (709) and no further processing is needed.

However, if the files provided are not already in a SUMA-compliant format (707), then the files may be converted to such a format. Again, the user generally does not make this determination; rather, the analysis and use of third party tools for conversion can be performed on the back end after the user was provided input files (701). Generally, the server will start with the closest-proximity data format conversion to reduce processing time. In the depicted embodiment, PLINK files can be simply converted directly to SUMA format, so the server begins determining whether the user input files (701) are in PLINK format (707). If so, then the PLINK user input files are converted to SUMA format (713), generally using a conversion script, though other techniques may be used. The converted files are suitable for processing and the system may proceed with the next step (709).

If the files are not in PLINK format, the depicted system may determine whether the user input files are in an input format that can be processed by PLINK, such as binary files obtained from a GWAS analysis (e.g., *.bed, *.bim, *.fam files) (715). If so, then the server may run PLINK, using the GWAS binary files as input and with the appropriate parameters (e.g., —recode 12 and—transpose) to generate .tped and .tfam output files (717). These output files can then be converted to a SUMA-compliant (713) format. If the files are not in a format that the system is programmed to be able to ultimately convert to PLINK text output (i.e., .tped and .tfam files that backend scripts can use as input to convert to SUMA format), then an error condition (719) has occurred from which the system cannot recover, and an error message may be generated.

Other processing on input files may also be done at this stage. For example, if the user indicates that the user desires statistical analysis of the SNP sets, the SUMA server software may convert the pertinent input files (i.e., genotype database and subject status files) into the proper format for the selected statistical analysis package. By way of example and not limitation, if the statistical analysis package is SKAT, the genotype database and subject status files may be converted to PLINK binary files. This may be done at this stage of the method, or later, depending upon how the server software is implemented.

Once input files (201), (203), and (205) are available in the expected format, the cluster identifying step (103) can begin. A purpose of this step is to identify in each of databases (203) and (205) the clusters which will be used in subsequent analysis. In one embodiment, this is done using factorization. In a further embodiment, Factorization of phenotype (203) data is performed independently of factorization of genotype data (205). In another embodiment, factorization of genotype data (205) is performed independently of factorization of genotype data (205).

Generally, it is contemplated that a generalized factorization method is used. In an embodiment, this method comprises one or more of factorization analysis, optimization research, and conceptual clustering approaches. These techniques address the problem of discovering interesting clusters (e.g., substructures or concepts) defined in distinct domains (e.g., phenotype and genotype), and the associated problem of determining interesting relations between those clusters.

In a still further embodiment, the factorization method is a non-negative matrix factorization (“NMF”) method. In a yet further embodiment, the NMF method uses is the bioNMF method, or another novel version of NMF, such as, but not necessarily limited to, Fuzzy NMF (“FNMF”). (See Pascual-Montano, A., Carmona-Saez, P., Chagoyen, M., Tirado, F., Carazo, J. M. and Pascual-Marqui, R. D. (2006) bioNMF: a versatile tool for non-negative matrix factorization in biology. BMC Bioinformatics, 7, 366, the entire disclosure of which is herein incorporated by reference) Techniques such as the newly proposed FNMF method herein have the advantage of allowing overlapping among submatrices and detection of outliers. The preferred embodiment, FNMF is the default factorization technique if the user does not select an alternative.

Other biclustering techniques are suitable for use with the method and some have been implemented and specifically tested with the method, including Cheng and Church, FLOC, and FABIA, which are also extended by the generalized factorization method. For a detailed discussion of Cheng and Church, see Cheng, Y. and Church, G. M. (2000) Biclustering of expression data. Proc Int Conf Intell Syst Mol Biol, 8, 93-103, the entire disclosure of which is herein incorporated by reference. For a detailed discussion of FLOC, see Yang, J., Wang, K., Wang, W. and Yu, P. (2003) Enhanced biclustering on expression data. IEEE Symposium on Biolnformatics and BioEngineering (BIBE '03), 1-7, the entire disclosure of which is herein incorporated by reference. For a detailed discussion of FABIA, see Hochreiter, S., Bodenhofer, U., Heusel, M., Mayr, A., Mitterecker, A., Kasim, A., Khamiakova, T., Van Sanden, S., Lin, D., Talloen, W. et al. (2010) FABIA: factor analysis for bicluster acquisition. Bioinformatics, 26, 1520-1527, the entire disclosure of which is herein incorporated by reference. Still other techniques are also suitable for use with the method and may be well-suited to certain analyses. Such techniques may be either already known in the art for particular analyses, or may be identified through ordinary experimentation and testing. Table 1 compares these fraternization techniques.

TABLE 1
Characteristics of the basic biclustering methods

| | | Structure of | |
|---|---|---|---|
| Method | Type of bicluster | biclustering | Approach |
| bioNMF | Information content | Non-overlapping | Sparse |
| | | | Factorization |
| FNMF | Information content | Overlapping | Sparse |
| | | | Factorization |
| Cheng&Church | Constant | Non-overlapping | Top-Down |
| FLOC | Constant Rows | Overlapping | Bottom-Up |
| FABIA | Information content | Overlapping | Factorization |

Still other methods may also be used, alone or in combination. By way of example and not limitation, such methods may include one or of the following: model-based; consensus; fuzzy; possibilistic; and conceptual. By way of example and not limitation, the PGMRA server described above, implementing a SUMA software solution, utilizes multimodal and multiobjective optimization techniques.

In an embodiment, one or more factorization methods may be applied recurrently to the same set of input files to generate a plurality of clustering results. Typically, this is done using varying initialization parameters. In particular, it is specifically contemplated that each such successive run will operate with a different maximum number of clusters parameter. That is, each run will be configured to allow up to a different maximum numbers of resultant clusters. This reduces the influence of user bias or assumptions concerning the ideal number of clusters, and allows the algorithm to more freely identify the clusters inherently expressed by the data.

However, it is generally preferred to impose at least some rational ceiling on the number of clusters. This can serve both computational and practical concerns, as it may inhibit excessive minute clustering, particularly for highly variant data, wherein the number of clusters produced by the algorithm begins to approach the number of samples, resulting in a large number of small clusters that do not meaningfully distinguish feature expression patterns from inherent variance among individuals in the sample. In the typical embodiment, the minimum number of resultant clusters is two, and the maximum is \sqrt{n}, where n is the number of subjects (i.e., the number of samples/rows in n×p matrix M). While \sqrt{n} is used the depicted embodiment, other values may be possible and, in some embodiments, preferred, including but not necessarily limited to arbitrary degree root or non-root models.

It should be noted that biclusters can be identified without choosing a priori a particular number of clusters. (Bittner and Smith, 2003; Fraley and Raftery, 1998; Fred and Jain, 2005; Latorre Carmona et al., 2013; Senbabaoglu et al., 2014). Setting this parameter as a small number may eventually generate few but large data partitions here defined as general biclusters that may underfit the data. In contrast, using a big number of clusters will generate many clusters with partitions of small size (i.e., more granular partitions) here defined as specific biclusters that may overfit the data. (Cordon et al., 2002; Fraley and Raftery, 1998; Latorre Carmona et al., 2013; Saeed et al., 2012; Zwir et al., 2005a). Although there are many different validity indices that suggest the best number of clusters for a given dataset, they often produce contradictory results. (Bezdek, 1998; Bezdek et al., 1992; Bittner and Smith, 2003; Fraley and Raftery, 1998; Fred and Jain, 2005; Latorre Carmona et al., 2013). This problem is exacerbated when Centroid-based (e.g., k-means, NMF) or Distribution-based clustering (e.g., EM) approaches are utilized because two successive numbers of clusters may generate completely different cluster arrangements. (Bezdek, 1998; Bezdek et al., 1992) for a review).

Instead of dealing with different and controversial results often obtained from optimizing validity indices (Bezdek, 1998; Bezdek et al., 1992) that indicate a single number of clusters, biclusters may be calculated from partitions generated by all number of clusters between 2 and \sqrt{n} (Bezdek, 1998), where n is the number of observations (subjects). In an embodiment, the selection of the best clusters is postponed until all partitions are examined, so as to select a set of clusters that together provide an better or optimal description of the sample. These clusters could be chosen from different partitions that were generated by different number of clusters. (Bittner and Smith, 2003; Fraley and Raftery, 1998; Fred and Jain, 2005; Kim et al., 2009; Latorre Carmona et al., 2013; Senbabaoglu et al., 2014; Zwir et al., 2005a).

The number of runs may vary from embodiment to embodiment, or even from user to user and project to project. It should be noted that the method is not necessarily constrained by the number of runs, and it is generally preferred that multiple runs are performed, ranging in quantity from 2 to \sqrt{n}, where is \sqrt{n} is the number of observations or subjects.

In the depicted embodiment of FIG. 1, for each run, and for each of the genotype (205) and phenotype (203) databases, clusters are selected. The selected clusters comprise a set of phenotype biclusters P={P₁, . . . , Pₘ} (207), as well as a separate set of genotype biclusters G={G₁, . . . , G₀} (209). One or both sets (207) and/or (209) may comprise overlapped, partially redundant, and/or differently-sized biclusters.

This technique for identifying the cluster sets has several advantages. First, the impact of user bias on the procedure is reduced. This is done by reducing bias imprinted through user parameter selection, such as the number of clusters, as well as removing from the clustering analysis prior knowledge of other studies (as in meta-analysis) or genomic features (as in pathway analysis). Further, this approach can disregard the status of the subjects in the data set when identifying SNP or phenotype sets. This form of unsupervised learning reduces the impact of external factors, such as human interpretation and coding of subject states, on the results. In other words, this approach allows for more pure exploratory data mining, facilitating the identification of patterns inherently expressed in the data, and reducing the extent to which the researcher influences the analysis to reveal what the researcher is looking for or expects to be present. This not only reduces the impact of analytical shortcomings such as confirmation bias, but may identify unexpected or unintuitive results that might otherwise be dismissed or overlooked.

The identified clusters (207) and (209) will be used in later processing and are generally stored in a temporary but durable fashion, such as in a temporary file or folder on storage media, or in a database. In an embodiment, the resulting bicluster (207) and (209) are provided, displayed, or otherwise made available to the user, such as for download. Such intermediary data may be useful, such as for reproducibility in peer review.

Next, the method discovers (105) a set of significant phenotype-genotype relations (211) among the identified phenotype (207) and identified genotype clusters (109). This set of relations may be referred to herein as R_{i,j}. In the depicted embodiment, the set of phenotype-genotype relations (211) are identified by cross-correlating the phenotype (207) and genotype (209) biclusters, calculating the pairwise probability of intersection among them using R_{i,j} statistics (PI_{hyp}) on the subject space. An exemplary formula is set forth in equation 4 of this disclosure. Permutations are used to build an empirical random distribution of PI_{hyp} to estimate the upper non-random p-value of an identified relation.

Next, the method organizes (107) the discovered relations (211) into local partitions, or niches. In the depicted embodiment, this is generally done by identifying relations (211) in the set which describe similar subjects. This identification may be done by calculating the distance matrix Ds among all phenotype-genotype relations R_{i,j} (211) using the PI_{hyp} metric on the subjects space. Then, the relations (211) are themselves clustered, using Ds as an intra-clustering distance metric, where each resulting cluster constitutes a partition or “niche” of relations describing similar subjects. In an embodiment, this may be done based on multimodal and/or multiobjective Pareto-like optimization research techniques.

Next, relations may be encoded (109) into topologically organized networks. For sake of clarity and the avoidance of doubt, the term “network” in this context refers not to a telecommunications or data network as previously defined herein, but rather to a logical or statistical network built upon graph theory. Redundant relations may appear due to the recurrent application of the factorization method described with respect to step (103). To identify optimal and non-redundant relations, the method calculates the distance matrix Dp among all phenotype-genotype relations R_{i,j} (211) within a partition or niche. In the depicted embodiment, this is done by using the PI_{hyp} metric on the phenotype space. Next, all relations in R_{i,j} (211) with PI_{hyp} (R_{i,j}, R_{k,l})<10E-6 (i.e., sharing targeted subjects, phenotype and genotype features) are eliminated from the partition. The remaining relations in the partition may then be organized into topologically organized networks using a statistical method or technique for comparing similarity or diversity of sample sets. By way of example and not limitation, this may be done using a Jaccard index or Jaccard similarity coefficient, or other techniques known in the art. An exemplary formula is set forth in equation 5 of this disclosure.

As with other intermediate data, the results of this step may be displayed, accessed, or otherwise made available to the user. For the encoding (109) step in particular, nested relations encode both sensitive and specific relations, both of which harbor distinct predictive power. As such, the resulting network nodes may be displayed to the user as a data visualization, such as by generating a network diagram for display via the web server. Alternatively, network data and/or metadata could be generated in a standard format for use with third party viewing tools, allowing the user to view and manipulate the resulting network without being confined to the functionality of a web browser or in-browser application. Node relationships may be indicated with arrows or other visual components. The determination of which relationships are indicated in the visualization, and how, will vary from embodiment to embodiment, and with changing tastes, preferences, and trends in visual design. By way of example and not limitation, in the preferred embodiment, nodes are indicated as related on a threshold of greater than 50% of inclusion.

Next, the method ranks or orders (109B) features within each optimal relation. In the depicted embodiment, this generally uses its entropy. To identify the relevance of a given feature, and the corresponding ranges of its values that characterize each relation R_{i,j} (211), the method labels each subject within and outside a given relation with two different categorical classes, sometimes also referred to as latent classes. Then, for a given relation R_{i,j} (211), the method calculates one decision tree per domain (e.g., phenomic (203) and genomic (205)). The resulting decision trees rank the utility of the features from top to bottom. That is, each tree separately projects the relation R_{i,j} (211) onto a different input domain (in this example, phenomic (203) and genomic (205)).

Generally, a decision tree uses the entropy to first choose the most relevant feature for a relationship R_{i,j} (211), where “most relevant” generally means the most important feature to distinguish a particular relationship R_{i,j} (211) from relationships. The ranking is both ordinal and quantitative, as the ranking is estimated by the entropy, and used to build a tree in a top-down fashion, where the top-most features are the most relevant for a given relationship as determined according to this method. Typically, this process is unsupervised, meaning no human operator or supervisor indicates whether a given relationship R_{i,j} (211) corresponds to a particular disease (or not). That is, the distinction is derived from a given relationship R_{i,j} (211) being different from other relationships (e.g., distinct subjects and/or features in the inputs—here, genetic and/or phenotypic domains). The relationships thus generate unlabeled classes that are subsequently labeled for the purpose of distinguishing one from another.

Next, the method maps (113) a disease risk function. In the depicted embodiment, this is done by first estimating the risk function of the network. The method incorporates a posteriori the status of the subjects composing each relation. Each relation is encoded into a 3-tuple (X,Y,Z), where X and Y correspond to the phenotype (203) and genotype (205) dimensions of the relation, respectively, and Z is a calculated risk variable. In the depicted embodiment, Z is calculated using a weighted average of epidemiological risks of all subjects in the relation. An exemplary formula is set forth in equation 6 of this disclosure.—eqn. 6. Relations are then placed along the phenotype (x-axis) and genotype (y-axis) dimensions by clustering them using phenotype and genotype distance matrices, respectively, based on the PI_{hyp} metric. The 3-tuples can then be interpolated and plotted in a data visualization. In the depicted embodiment, the visualization is a three-dimensional disease risk surface (113) projected to a two-dimensional plane for convenient display by computer.

It should be noted that the subject status (i.e., classification of the subjects as patients or controls) is generally not used in the method to this point, though the classification data may exist and be available throughout the method. If there is sufficient data to classify the subjects as patients and controls, the algorithm may incorporates the classification into each relationship to estimate its risk, transforming an unsupervised relationship into a supervised relationship. However, this preferably occurs after the identification of the relationship in the first instance.

The particular visualization may vary from embodiment to embodiment, and may also vary depending upon the characteristics of the resulting 3-tuple set. By way of example and not limitation, where the set comprises extreme points and/or outliers, a three-dimensional surface projection may be difficult to interpret visually because large portions of the surface are obscured, or the scaling required to fit the plot into a displayable model may remove too much detail. In an embodiment, the resulting visualization is user-manipulable, allowing for panning, rotating, varying zoom levels, and other perspective changes.

Finally, the method may comprise analyzing (115) the statistical significance of a particular genotype associated with a disease (i.e., the significance of multiple SNPs within a SNP set belonging to a relation R_{i,j}). In the depicted embodiment, this is done by first transforming an unsupervised relation into a supervised relation, typically through a labeling exercise. Second, a third-party tool may be used, preferably Package SKAT (Lee, Miropolsky, Wu), or another implementation of the IBS kernel-machine method. SKAT is preferred to evaluate SNP sets because it accounts for multiple-correction as well as for the degrees of freedom of the test. Other kernel machines or regression analyses may be used.

Although the user may indicate via the interface the use of the IBS kernel-machine test on each of the SNP sets found, each testing is time consuming and may increase processing time, as discussed below. This is in part because each SNP set/relation is independently submitted, as they are not disjoint and cannot fill up a single input file.

The above method provides a number of advantages, in addition to those advantages already described herein. First, input parameters can belong to a plurality of relations, notably subjects, SNPs, and/or phenotype features. Second, SNPs within a SNP set may be located anywhere in the genome. Third, the dimensionality of phenotype features is not reduced in the analysis. This is an advantage over other techniques, notably Principal Component Analysis and similar approaches, because in the field of phenomics important features are a priori not known. Fourth, bias is reduced by eliminating a predefined number of SNP sets, phenotype sets, and/or relations among them. Fifth, many-to-many relations among SNP and phenotype sets are identified in an unbiased fashion by using the probability of subject intersection, without consideration of the subject's disease status (e.g., cases, controls). Finally, bias in estimating disease risk is reduced by incorporating a posteriori the subject status within each relation, weighing the frequency of each type of status (e.g., cases, relatives, controls), and mapping it to a predictive risk surface. Moreover, after the latter process, the statistical significance of interactions of SNPs associated with the disease can be estimated. SUMA thus provides a quick snapshot of a single GWAS in a readidly interpretable format. Further, intermediate and final outputs of SUMA server analysis may be used as input for other or further analysis in other servers.

As described elsewhere herein, the SUMA server is both hardware and software, comprising a computer server communicably connectable to client computers over a telecommunications or data network (chiefly the Internet, or an internet). The computer server in turn comprises software components that make up the SUMA package. SUMA generally comprises a web server component and a backend component. The web server component implements web services generally according to established web communication protocols and design principles. The backend component implements the systems and methods described herein. Users generally do not interact directly with the backend components, but rather provide data and commands through a web interface presented via the web server.

In an embodiment, the SUMA web server is implemented using PHP, and may further comprise one or more shell scripts (e.g., bash, ksh, csh, etc.) that communicate with one or more software packages implementing a biclustering technique, and/or with other pre- and/or post-processing scripts, including Perl and R scripts. Computationally intensive algorithms, such as the biclustering methods, are typically implemented in lower-level languages with a relatively tight command relationship to native machine language, such as C or assembly. However, such packages are typically invoked or called through wrappers in higher-level languages (e.g., Perl or R), where the underlying libraries are linked at compile time or runtime.

In an embodiment, one or more R-project packages may be used in aSUMA implementation, including but not necessarily limited to: pheatmap for the heatmap graphs; latticeExtra, akima, tgp, animation and plotrix for the 3D risk graph; rpart and rpart.plot for the classification trees; SKAT for the statistical analysis of SNP sets; graphviz for network graph generation; and, biclust, fabia and BicARE for the Cheng & Church, FABIA, and FLOC biclustering methods, respectively (Tables 1-2).

TABLE 2
Parameters of the basic biclustering methods

| Biclustering | Name | Type | Importance | Min. | Max. | Def. |
|---|---|---|---|---|---|---|
| bioNMF | Min Clusters | Int | Basic | 2 | Inf | 2 |
| | Max Clusters | Int | Basic | 2 | Inf | Auto |
| | Sparseness | Real | Advanced | 0 | 1 | 0.5 |
| FNMF | Min Clusters | Int | Basic | 2 | Inf | 2 |
| | Max Clusters | Int | Basic | 2 | Inf | Auto |
| | Sparseness | Real | Advanced | 0 | 1 | 0.5 |
| | Fuzziness | Real | Basic | 0 | 1 | 0.5 |
| Cheng&Church | Min Clusters | Int | Basic | 2 | Inf | 2 |
| | Max Clusters | Int | Basic | 2 | Inf | Auto |
| | Delta | Real | Advanced | 0 | Inf | 0.1 |
| | Alpha | Real | Basic | 0 | Inf | 1.5 |
| FLOC | Clusters | Int | Basic | 1 | Inf | 10 |
| | Row variance | Real | Basic | 0 | Inf | 0.05 |
| | Min Samples | Int | Advanced | 2 | Inf | 10 |
| | Min Genes | Int | Advanced | 2 | Inf | 8 |
| | Iterations | Int | Advanced | 1 | Inf | 500 |
| | pGene | Real | Advanced | 0 | 1 | 0.5 |
| | pSample | Real | Advanced | 0 | 1 | 0.5 |
| FABIA | Min Clusters | Int | Basic | 2 | Inf | 2 |
| | Max Clusters | Int | Basic | 2 | Inf | Auto |
| | Alpha | Real | Advanced | 0.1 | 1.0 | 0.1 |
| | Iterations | Real | Advanced | 1 | Inf | 500 |
| | L sparseness | Real | Advanced | 0.5 | 2.0 | 0.5 |
| | Z sparseness | Real | Advanced | 0.5 | 2.0 | 0.5 |

An important consideration is execution time, as the size of the inputs can lead to enormous solution sets that, even with the benefit of computationally powerful hardware, may require extensive clock time to complete operations. Because a use of the methods described herein is as a diagnostic tool, and in particular as a diagnostic tool for mental illnesses, which are often progressive in nature and benefit from early diagnosis and intervention, time is of the essence in completing the analysis to aid in rendering a diagnosis and prescribing appropriate therapy for the patient. One of ordinary skill in the art will readily understand that the assistance of computer technology is required to complete the analysis in a diagnostically useful timeframe. Even assuming that non-computer-implemented alternatives could provide complete and accurate calculations at all, such results would not be available in a diagnostically relevant time frame.

The time of execution can vary from a few minutes to several hours or days depending on the size of input files and the selected parameters. Experimentation has shown that the biclustering portion is generally the most time-consuming step. Where time constraints require results more rapidly, this step can be reduced by using one processor core for each cluster K (e.g., maximum number of clusters K is \sqrt{n}).

In one experiment, two GWA studies of schizophrenia were evaluated, each of which harbored different size and status of their respective subjects, as well as distinct phenotype features. These studies were termed small (70 subjects×8000 SNPs, corresponding to the genotype and phenotype test files provided in SUMA) and big datasets (2500 subjects×2700 SNPs). The processor time, using a maximum of K=\sqrt{n} biclusters, and implementing the FNMF method, was measured for different numbers of SNPs in each study. As described elsewhere herein, larger datasets are specifically contemplated, including “big data” processing ranging in the millions of SNPs and beyond.

Table 3 provides running time comparisons between SUMA using the small (70 subjects×8000 SNPs) and the big datasets (2500 subjects×2700 SNPs) corresponding to two different GWA studies of schizophrenia as inputs, and the FNMF biclustering method. K corresponds to the maximum number of biclusters and subsumes all previous K−1 runs if one core is utilized for each K. The SUMA server column indicates the elapsed computational time (in real world time) on native hardware where the web server is running. The native SUMA hardware is a 64-bit machine with two quad-core, two-GHz processors per node. HPC (1 core) indicates the elapsed computational time using the High Performance Computing hardware at Washington University in St. Louis (chpc.wustl.edu) using a single core per K. HPC (MPI—8 cores) indicates the elapsed computational time using the same High Performance Computing hardware with the Message Passing Interface (MPI) and 8 cores per K.

TABLE 3

| | | | | HPC (MPI-8 |
|---|---|---|---|---|
| | DataSet size | SUMA Server | HPC (1 core) | cores) |
| Big | 2500 × 2700 | 41 h 12 m 20 s | 35 h 09 m 34 s | 03 h 17 m 09 s |
| Dataset | (K = 50) | | | |
| | 2500 × 2000 | 30 h 40 m 19 s | 25 h 58 m 30 s | 02 h 23 m 19 s |
| | (K = 50) | | | |
| | 2500 × 1000 | 15 h 29 m 27 s | 13 h 06 m 40 s | 01 h 12 m 34 s |
| | (K = 50) | | | |
| | 2500 × 50 | 07 h 52 m 32 s | 06 h 37 m 00 s | 00 h 38 m 06 s |
| | (K = 50) | | | |
| Small | 70 × 8000 | 01 h 03 m 05 s | 00 h 37 m 41 s | 00 h 06 m 03 s |
| Dataset | (K = 9) | | | |
| | 70 × 4000 | 00 h 32 m 58 s | 00 h 21 m 52 s | 00 h 02 m 49 s |
| | (K = 9) | | | |
| | 70 × 2000 | 00 h 16 m 37 s | 00 h 10 m 45 s | 00 h 01 m 22 s |
| | (K = 9) | | | |
| | 70 × 1000 | 00 h 08 m 13 s | 00 h 05 m 34 s | 00 h 00 m 42 s |
| | (K = 9) | | | |

The experimental processing times reveal an improvement of ˜15% and ˜30% by using HPC versus the SUMA native hardware in the big and small datasets, respectively. However, more than 90% of improvement is achieved by using the HPC-MPI option in both samples (Table 3). Therefore, certain implementations may include an additional component comprising an on-demand or on-request off-line MPI SUMA service for large, time-consuming samples. This option may be preferable for users who do not wish to wait out the processing time of the SUMA server.

Experimentation was also conducted concerning the difference in performance of various biclustering algorithms, by comparing the running time for the small dataset for a fixed maximum number of biclusters K (Table 4). Both the bioNMF and FNMF methods allow different initializations per K (40 by default) to avoid local minimum partitions, which eventually increases the time of processing. In contrast, the other methods do not explicitly allow such an approach. Moreover, the former two classes of methods are qualitatively different, since they have different optimization fitness functions that eventually produce distinct results. For example, the Cheng & Church method tends to find homogeneous and crisp biclusters, whereas the bioNMF method tends to identify more general structures, which facilitates the uncovering of inter-domain relations with other biclusters.

Table 4 provides experimental running times for the small dataset (70 subjects×8000 SNPs) using different biclustering methods for a fixed maximum number of biclusters K.

TABLE 4

| Small Dataset | | | Cheng & | | |
|---|---|---|---|---|---|
| (K = 9) | BioNMF | FNMF | Church | FLOC | FABIA |
| 70 × 8000 | 1 h 3 m 5 s¹ | 1 h 3 m 5 s¹ | 0 h 39 m 15 s² | 3 h 43 m 11 s² | 0 h 4 m 51 s² |

The bioNMF and FNMF times are from methods that allow different initializations per K (40 by default) to avoid local minimum partitions. The Cheng & Church, FLOC, and FABIA times are from methods that do not explicitly allow different initializations.

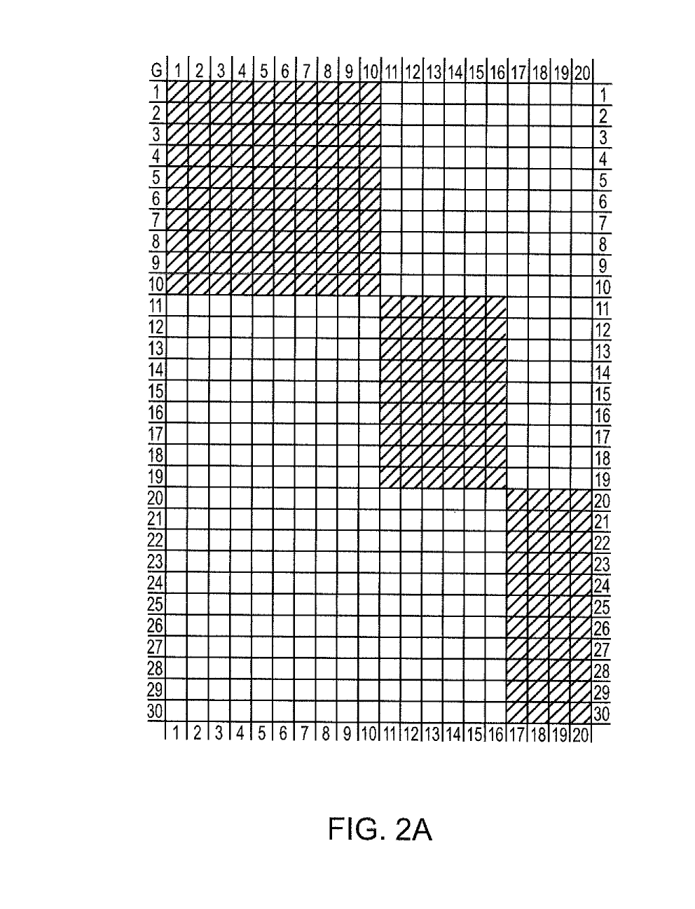

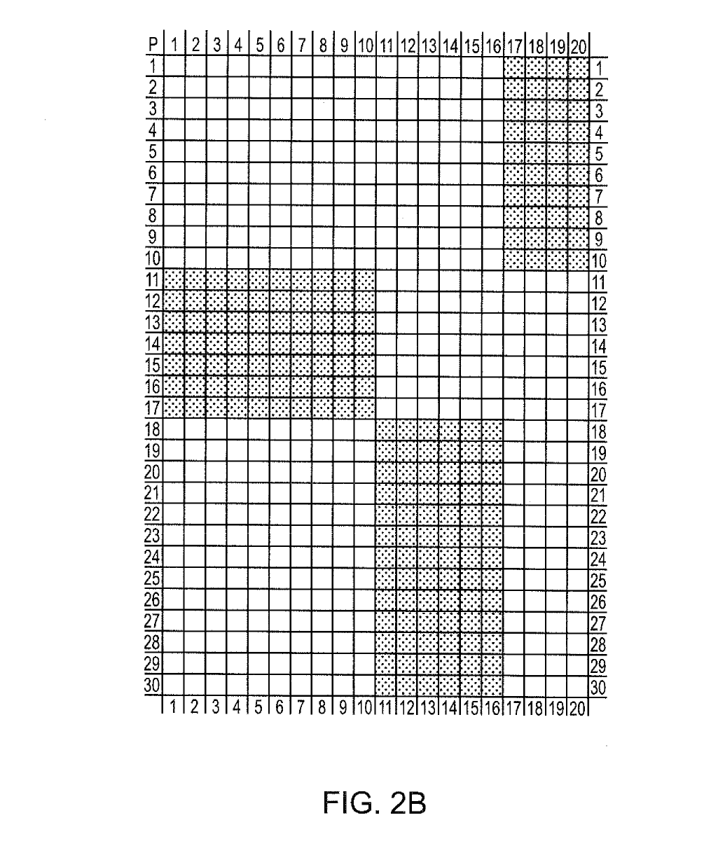

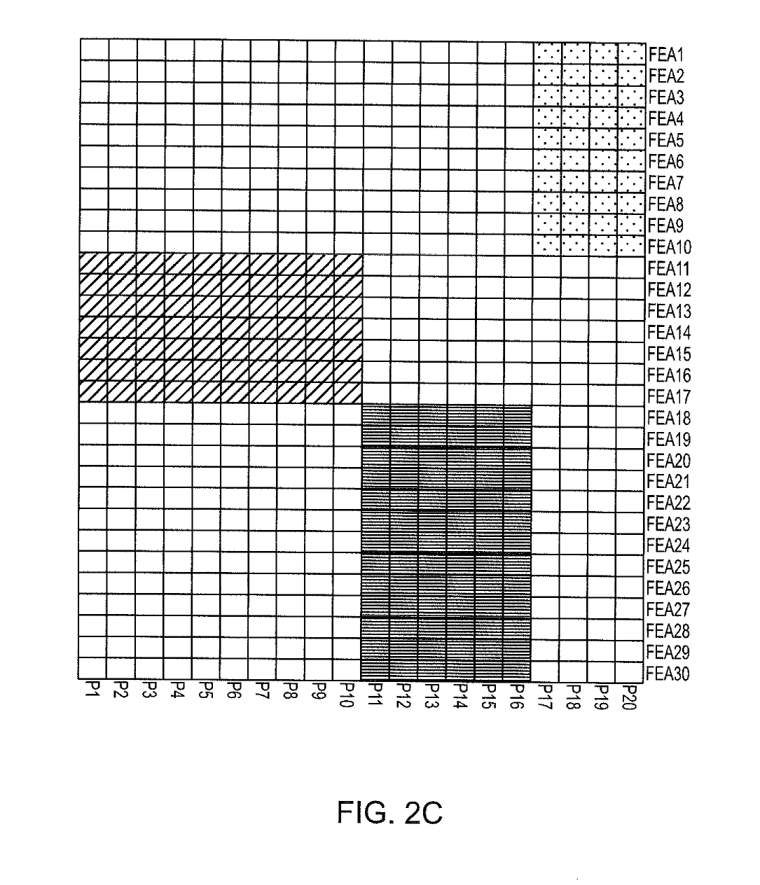

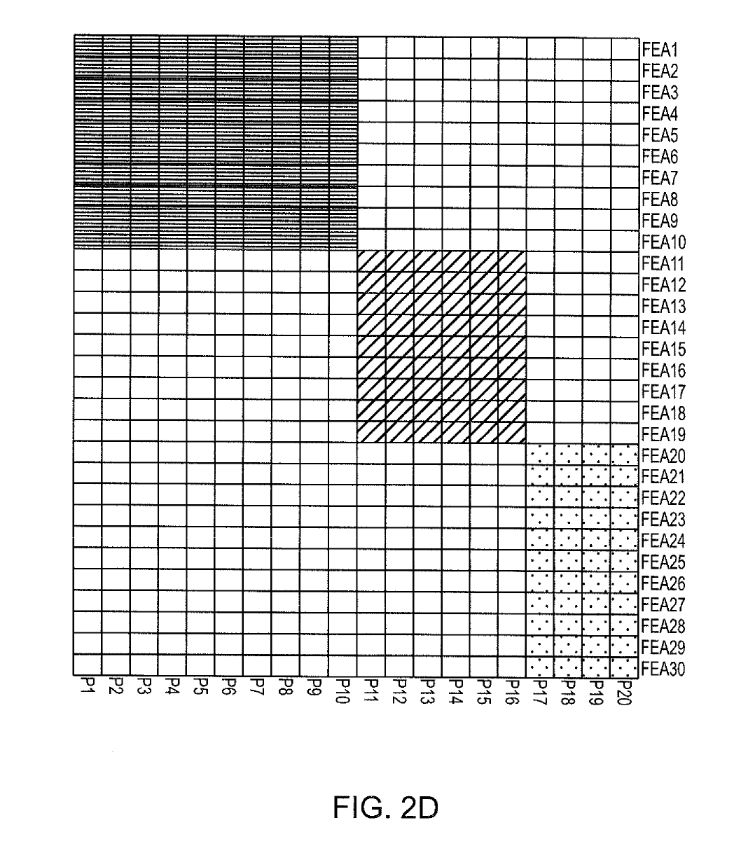

FIGS. 2A-2D provide a synthetic example comparing the ability of the bioNMF and FNMF methods to identify pre-defined crisp biclusters. In the depicted embodiment, default bioNMF parameters are applied for both methods, and a fuzziness threshold of 0.5 is used for the FNMF method. The depicted columns and rows in the synthetic matrices represent subjects (n) and features (p), respectively. The depicted matrix of FIG. 2A comprises 3 crisp biclusters, representing genotype data. The depicted matrix of FIG. 2B comprises 3 crisp biclusters represents phenotype data, and those biclusters are different from the biclusters in the matrix of FIG. 2A. It should be noted that the biclusters defined in each domain (genotype and phenotype) have a non-null intersection of subjects. In the depicted matrices of FIGS. 2C and 2D, the same biclusters identified by both the bioNMF and the NMF methods that correspond to the matrices of FIGS. 2A and 2B are depicted and the identified biclusters are highlighted.

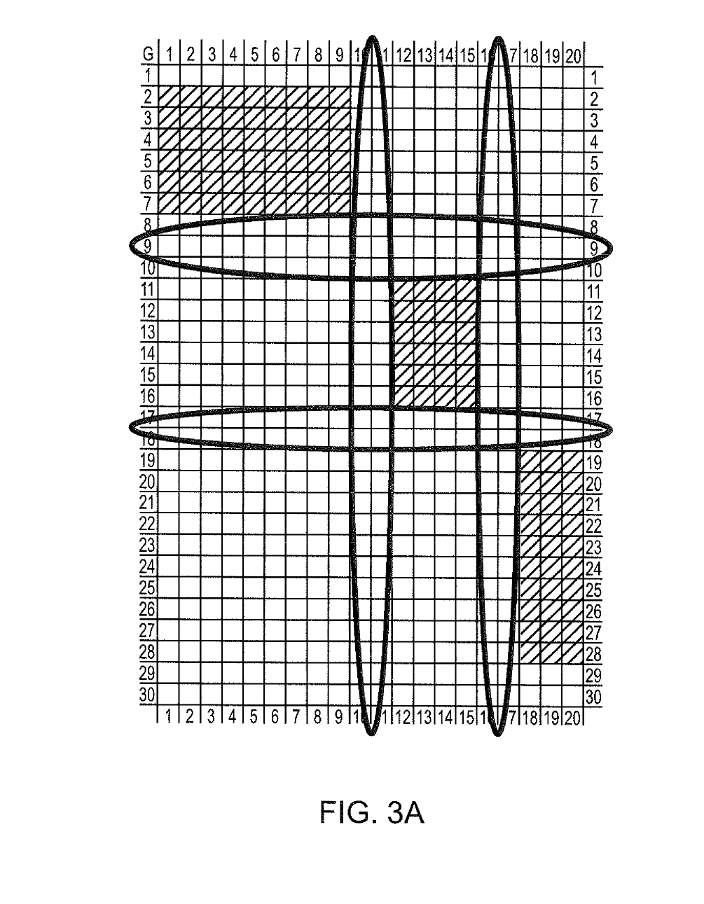

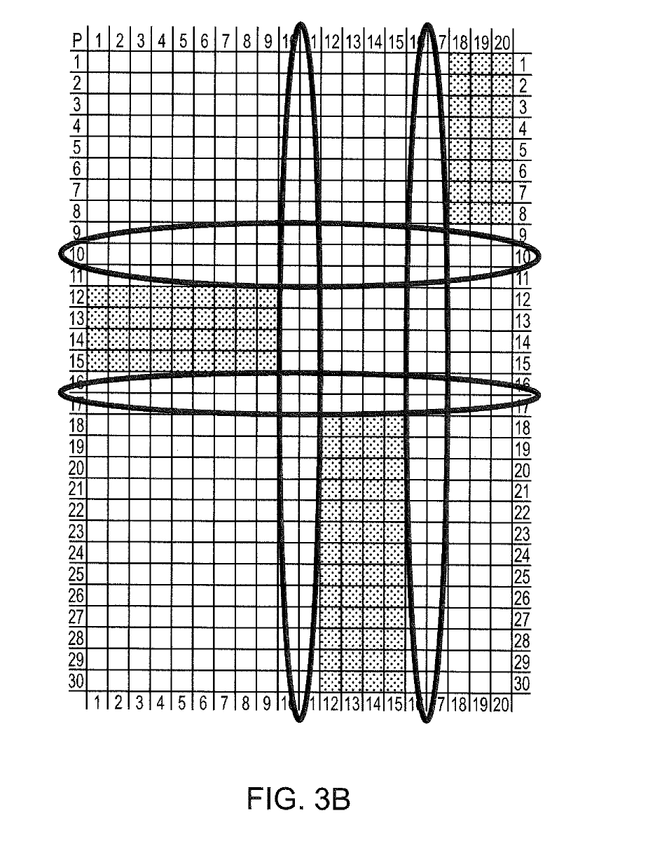

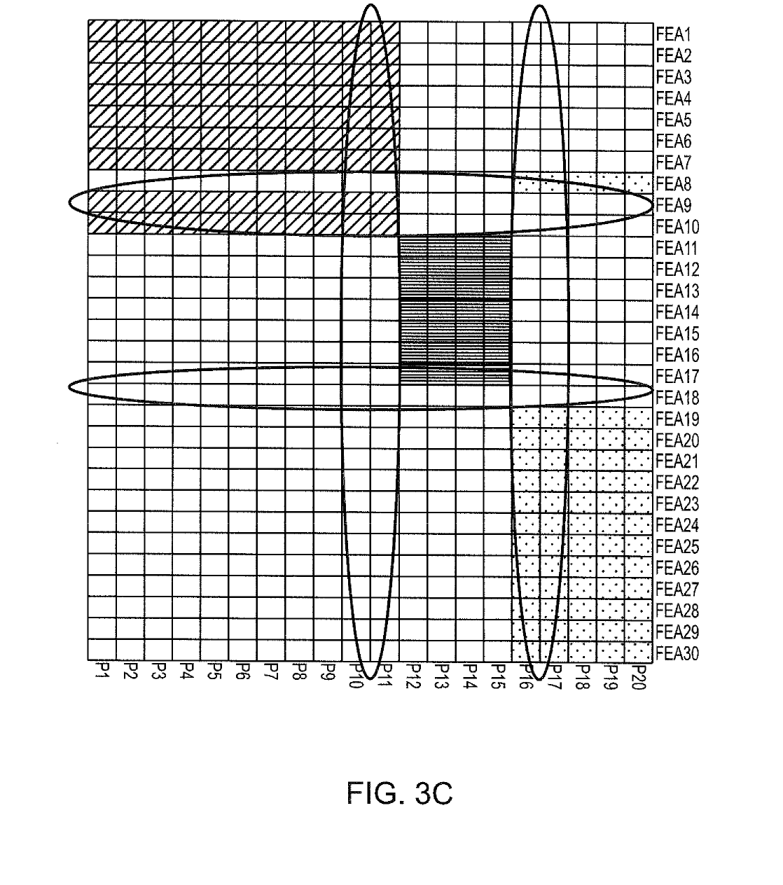

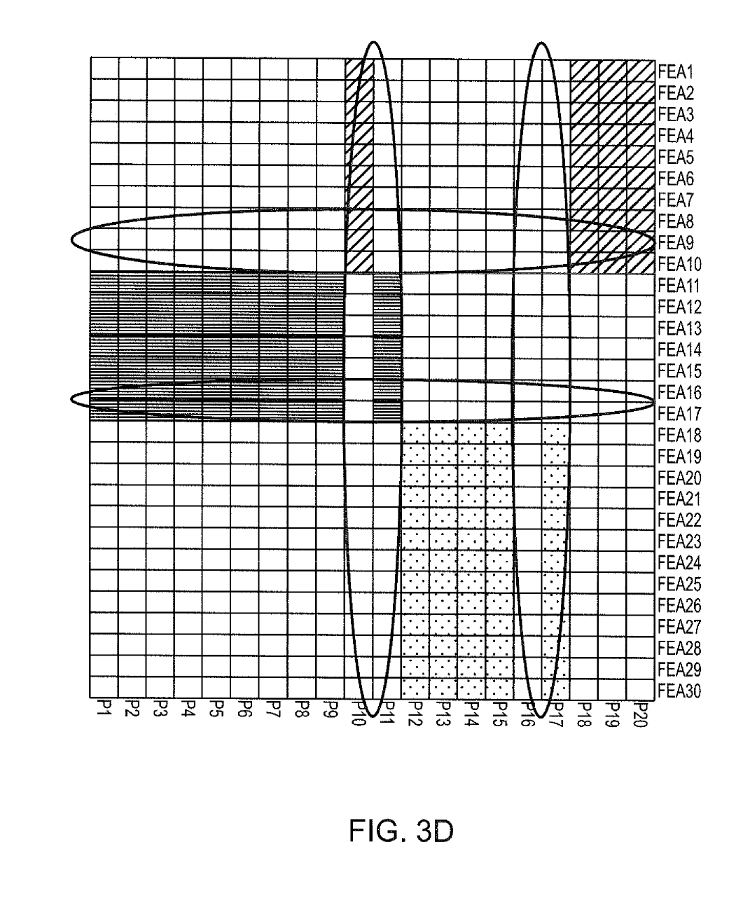

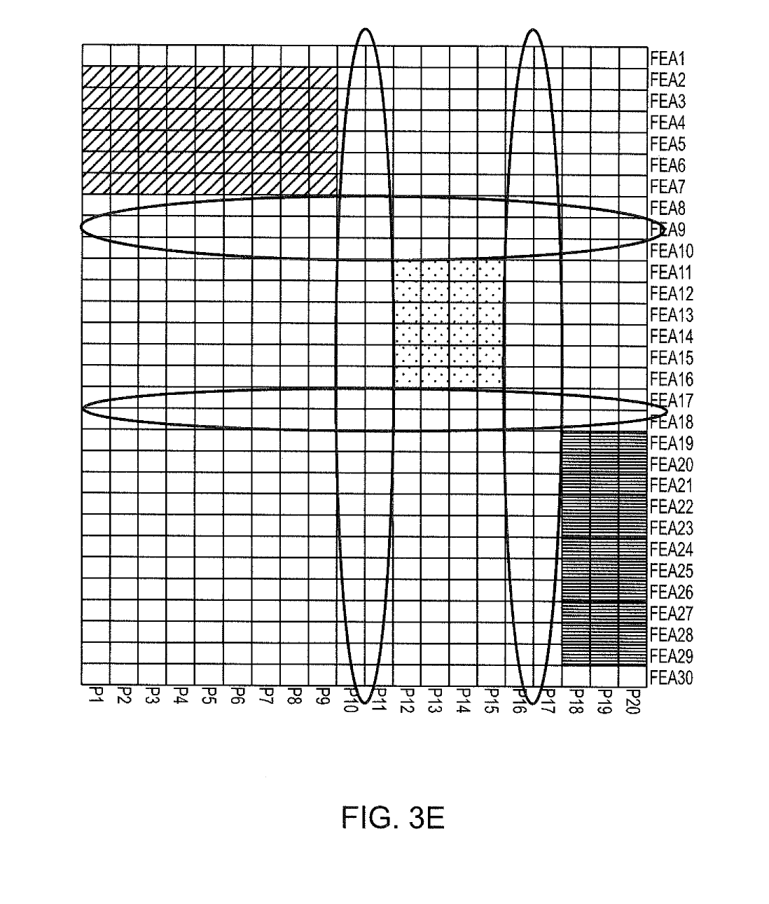

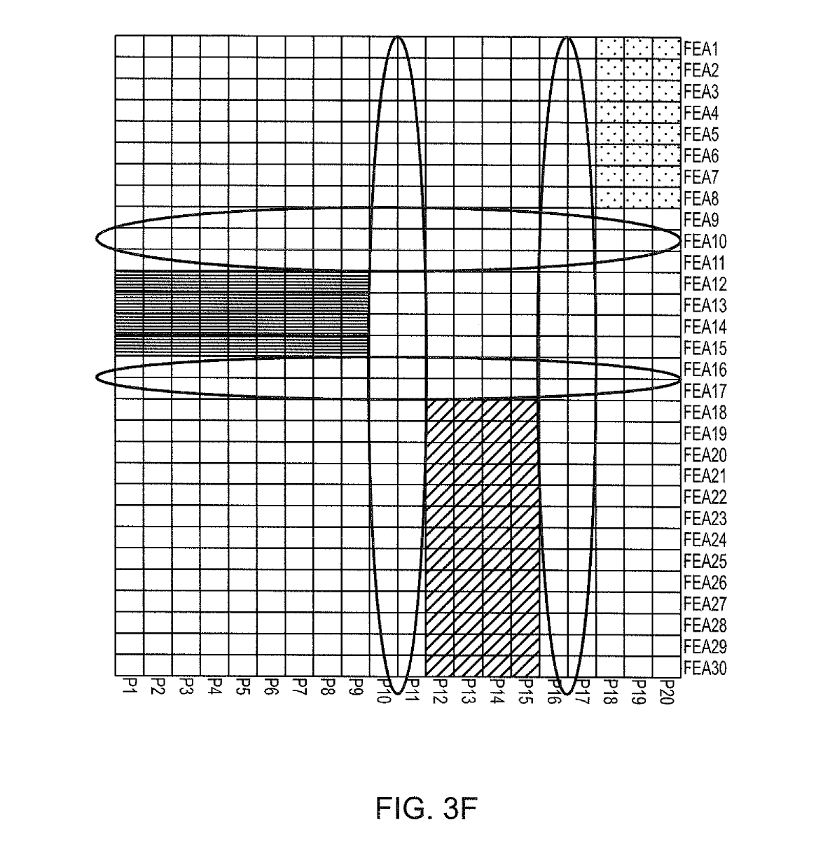

FIGS. 3A-3F provides a synthetic example designed to compare the ability of the bioNMF and FNMF methods to identify pre-defined biclusters with partitions harboring outliers (empty). In the depicted embodiments, default bioNMF parameters are applied for both methods (bioNFM and FNMF) with a fuzziness threshold 0.5 for the FNMF method. Each of the depicted columns and rows in the synthetic matrices represent subject and features, respectively. The depicted outliers are marked with ellipses. The depicted matrix of FIG. 3A comprises 3 crisp biclusters representing genotype data, with high-valued cells highlighted. The depicted matrix of FIG. 3B comprises 3 crisp biclusters representing phenotype data, with high-valued cells highlighted, where the biclusters are different from those biclusters in the matrix of FIG. 3A. Biclusters defined in both domains have a non-null intersection of subjects. The depicted matrices of FIGS. 3C-3D have biclusters corresponding to FIGS. 3A-3B and identified by bioNMF, where the outliers, empty rows and/or columns, are assigned to one bicluster (depicted with ellipses). The identified biclusters are highlighted. In the depicted matrices of FIGS. 3E-3F, biclusters corresponding to the matrices of FIGS. 3A-3B and identified by FNMF, where the outliers, empty rows and/or columns, are not assigned to the recognized bicluster (red ellipses). The identified biclusters are highlighted.

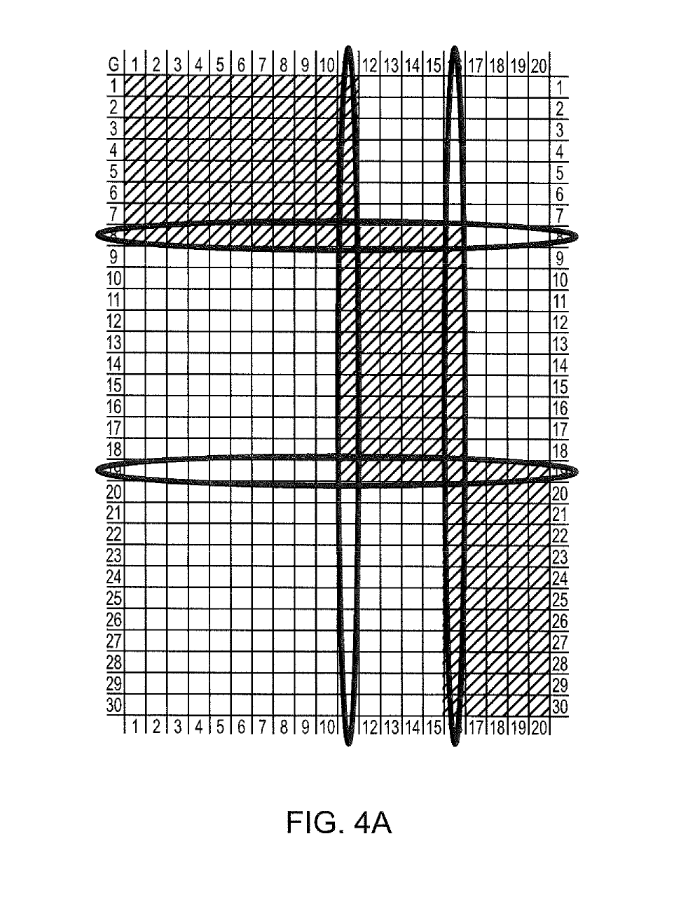

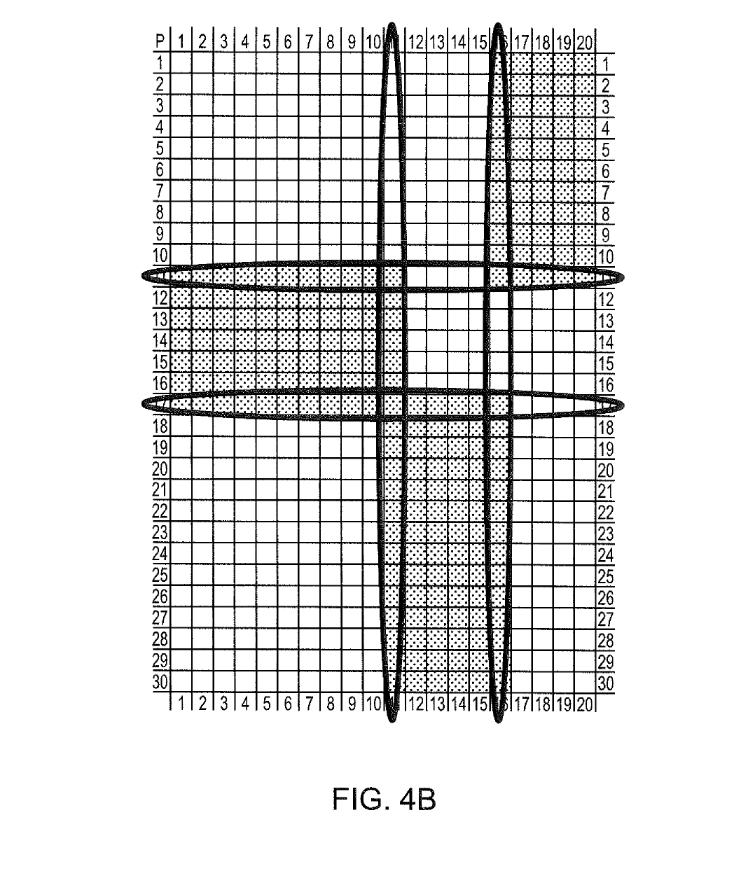

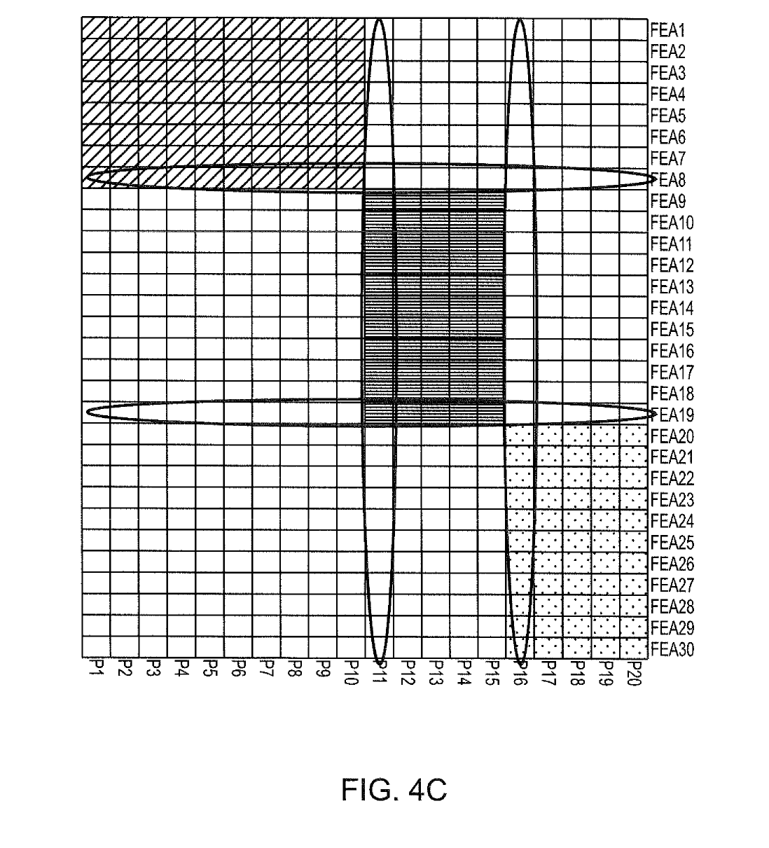

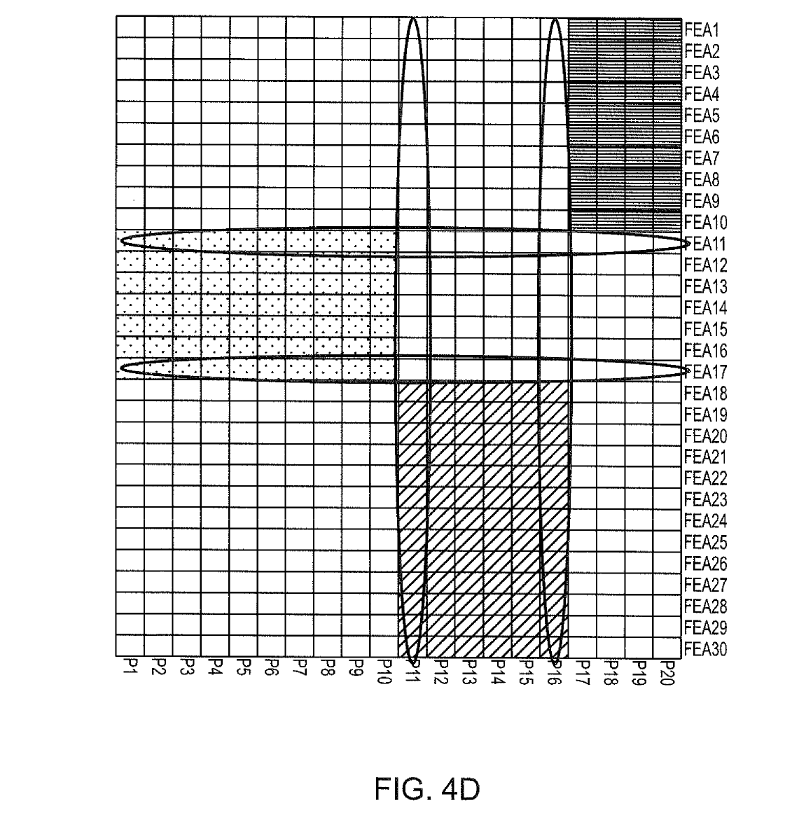

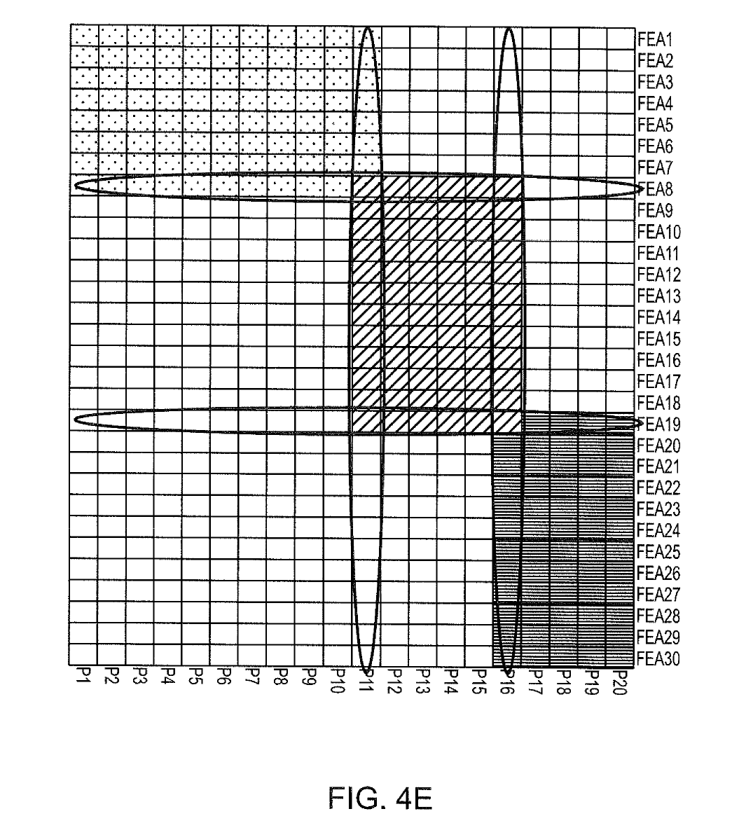

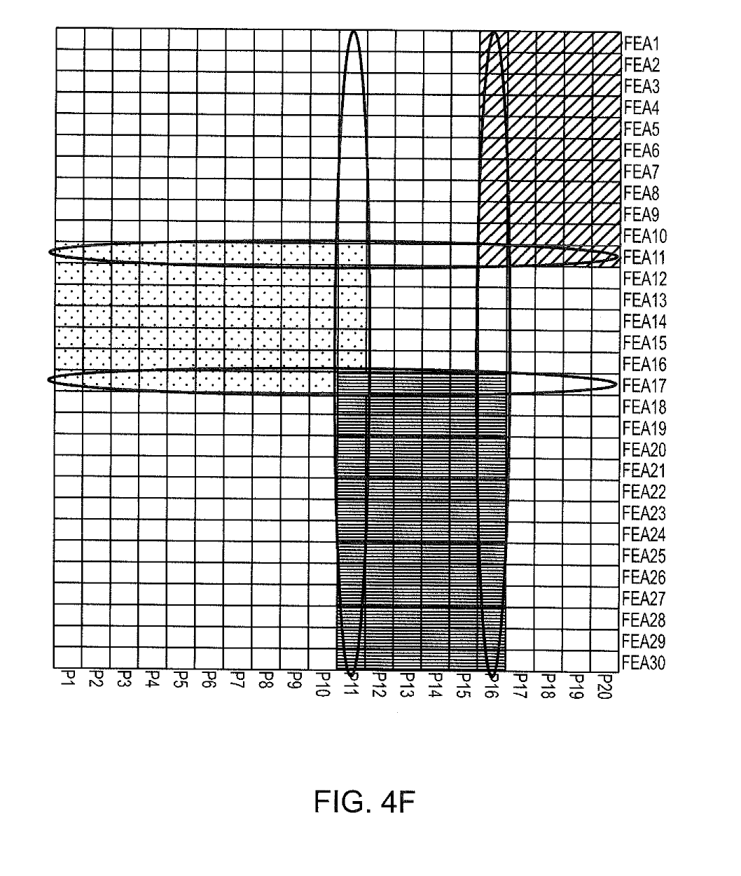

FIGS. 4A-4F provides a synthetic example designed to compare the ability of the bioNMF and FNMF methods to identify pre-defined biclusters with partitions harboring fuzzy/overlapped biclusters. Default bioNMF parameters are applied for both methods, and a fuzziness threshold=0.5 is used for the FNMF method. Each of the depicted columns and rows in the synthetic matrices represent subject and features, respectively. The overlapped rows and columns are marked with ellipses. The depicted matrix of FIG. 4A comprises 3 crisp biclusters representing genotype data, where the high-valued cells are highlighted. The depicted matrix of FIG. 4B comprises 3 crisp biclusters representing phenotype data, where the high-valued cells are highlighted, and where the biclusters are different from those biclusters in the matrix of FIG. 4A. Biclusters defined in both domains have a non-null intersection of subjects. The depicted matrices of FIGS. 4C-4D comprise crisp biclusters corresponding to the matrices of FIGS. 4A-4B and identified by bioNMF, where the overlapped rows and/or columns are assigned to one bicluster (depicted as ellipses). The identified biclusters are highlighted. The depicted matrices of FIGS. 4E-4F comprise biclusters corresponding to the matrices of FIGS. 4A-4B and identified by FNMF, where the overlapped rows and/or columns are assigned to multiple biclusters (depicted as ellipses). The identified biclusters are highlighted.

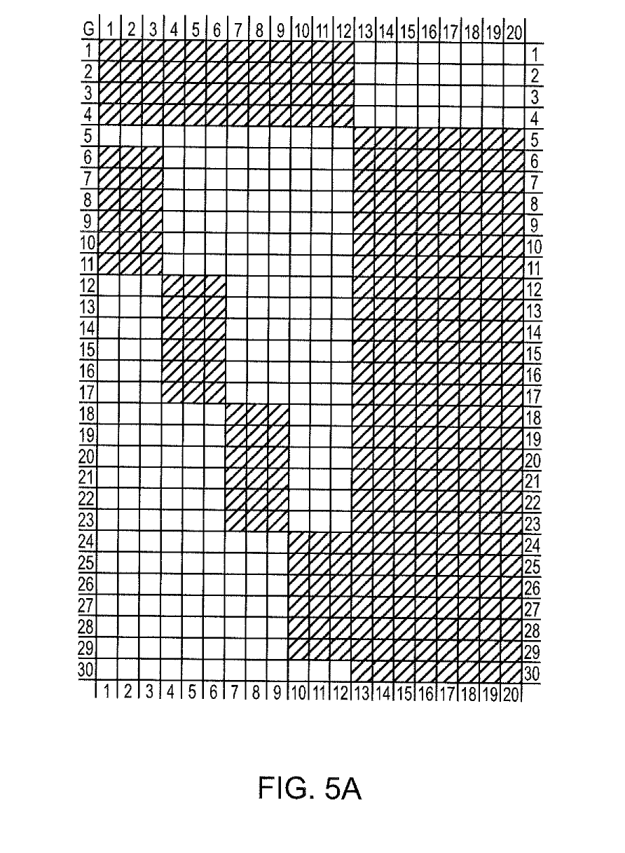

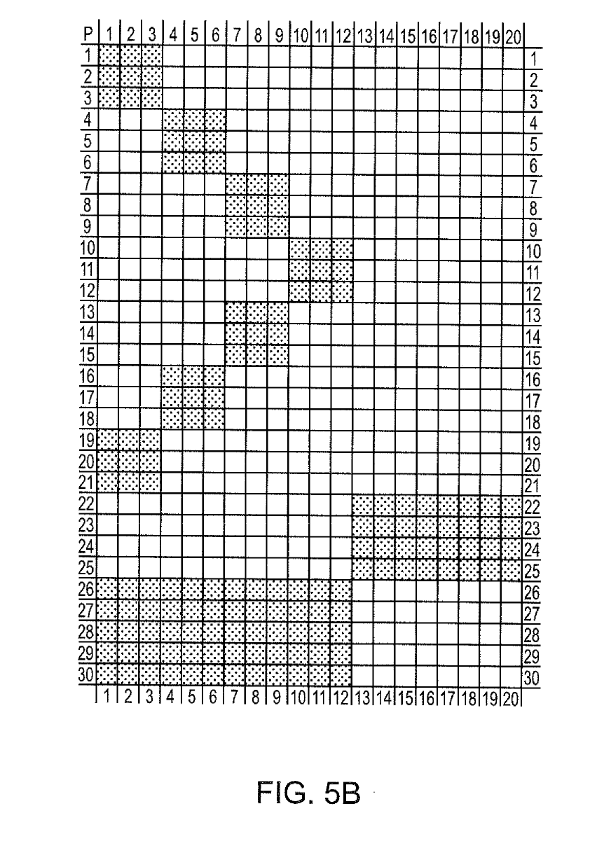

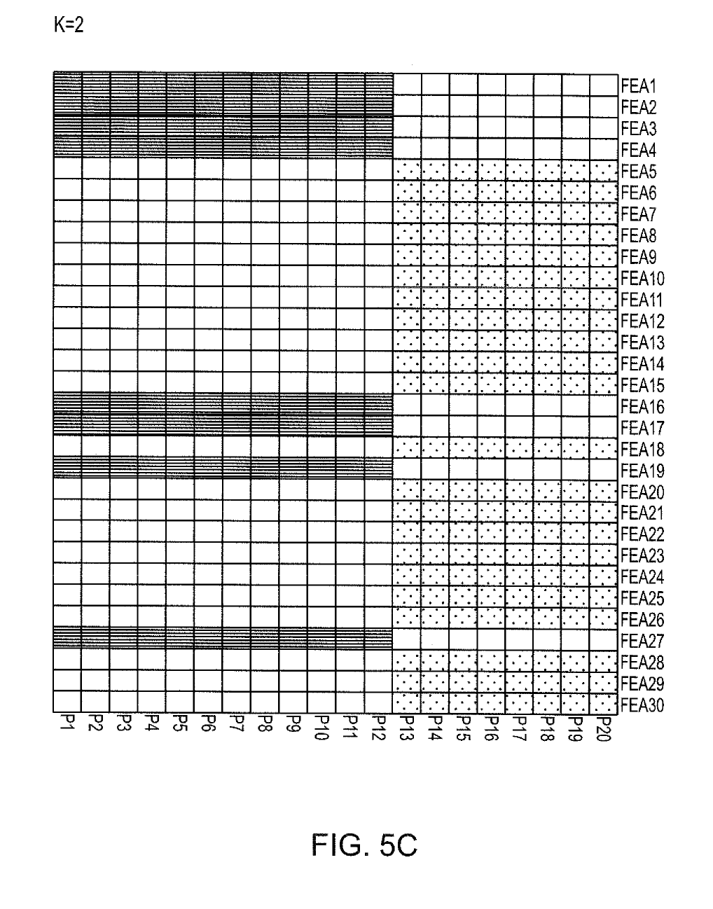

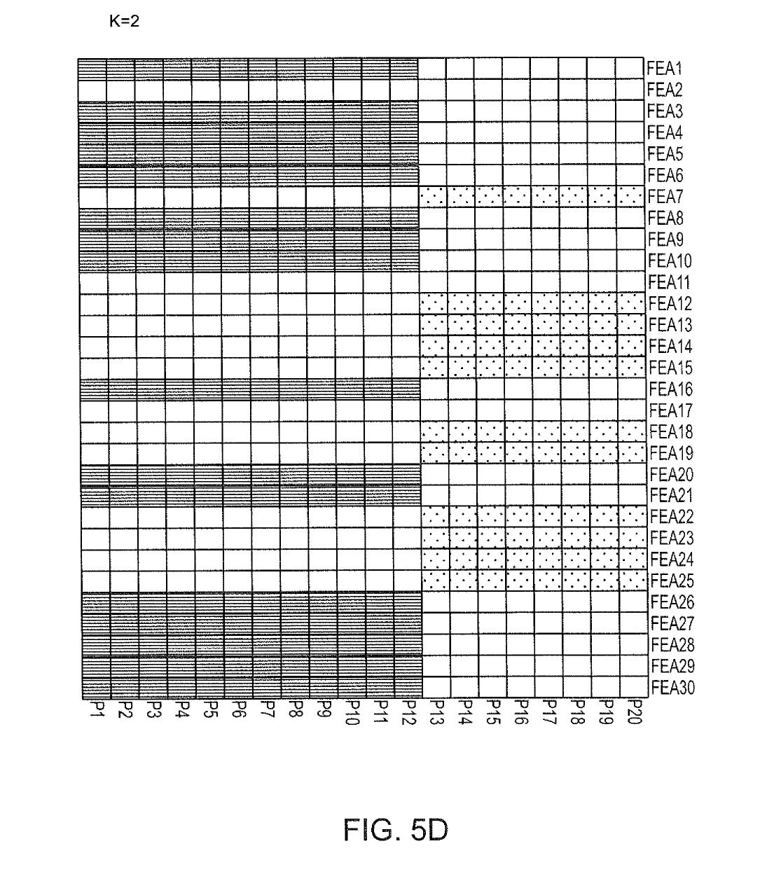

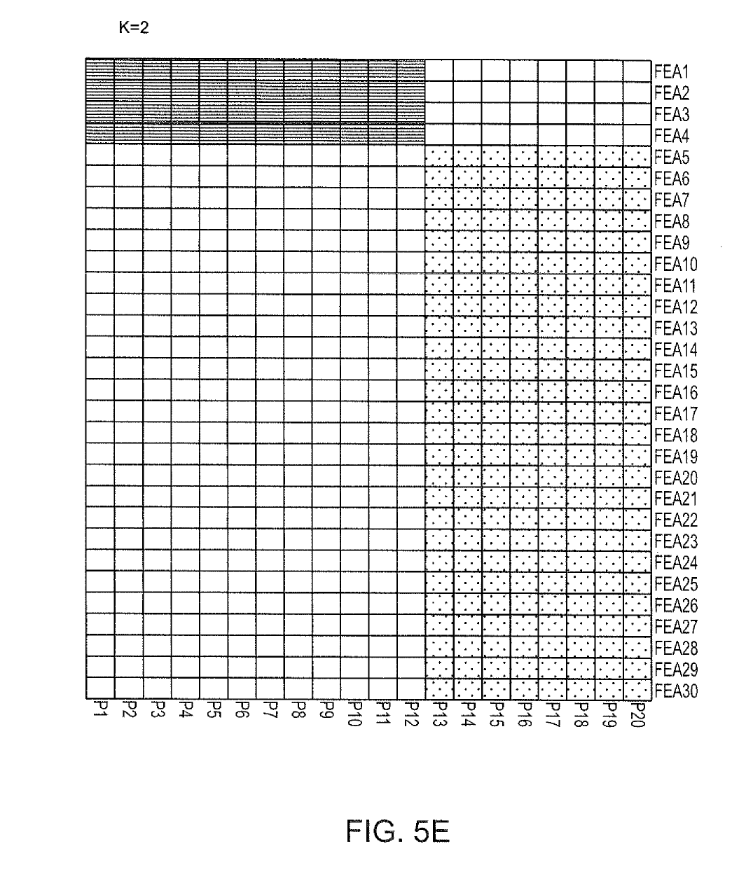

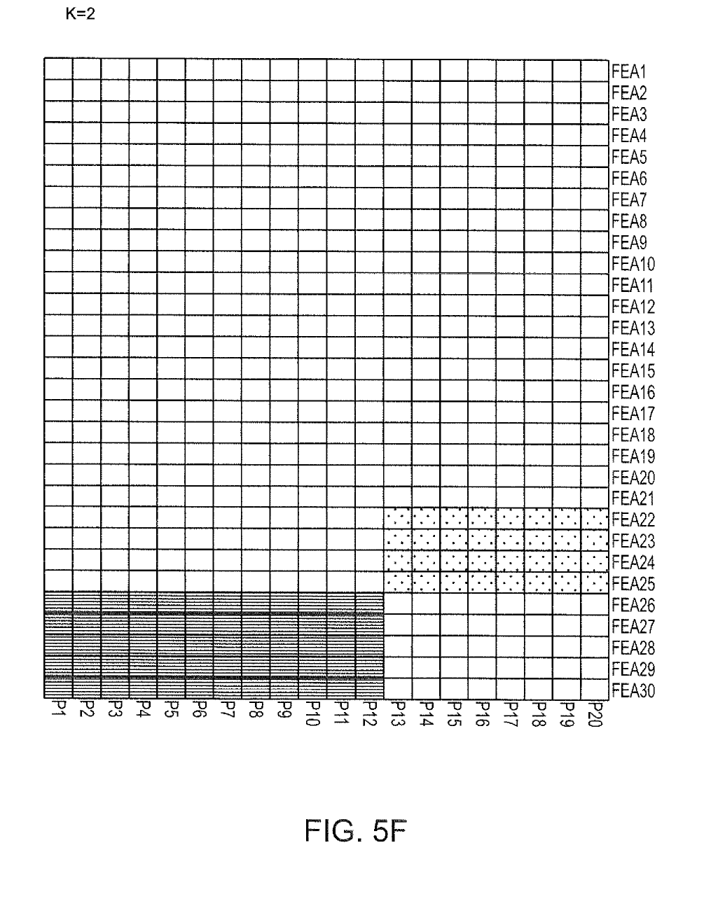

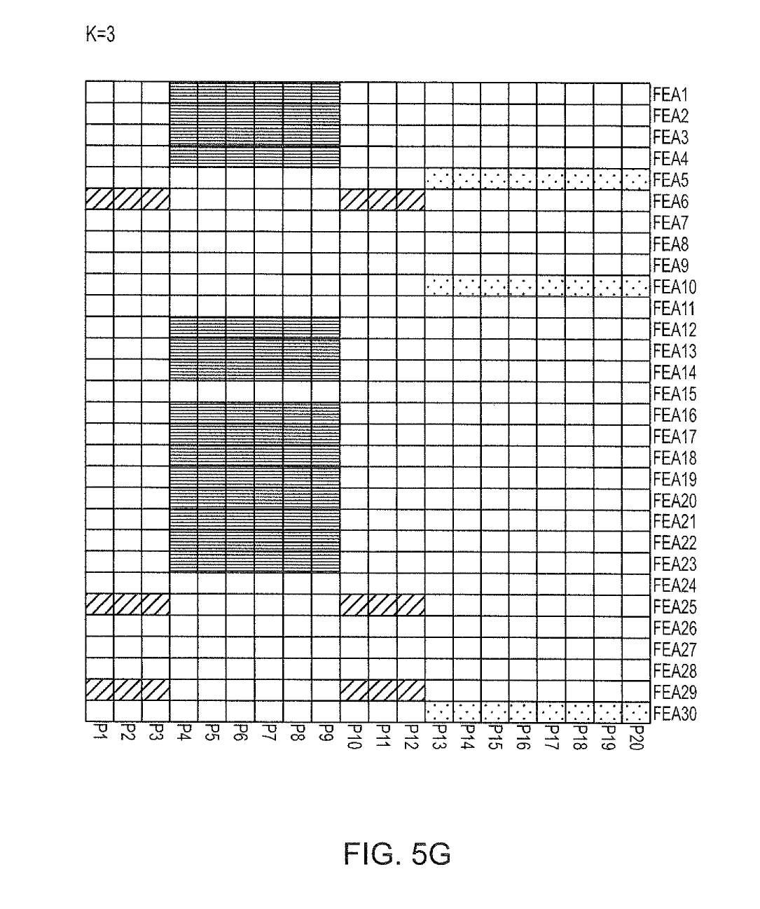

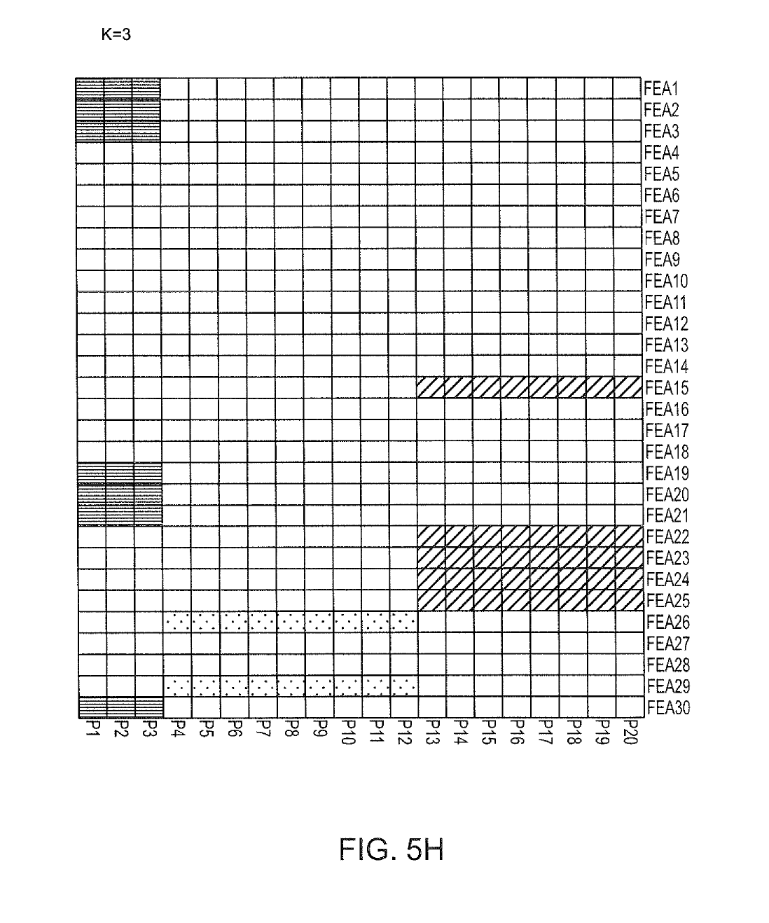

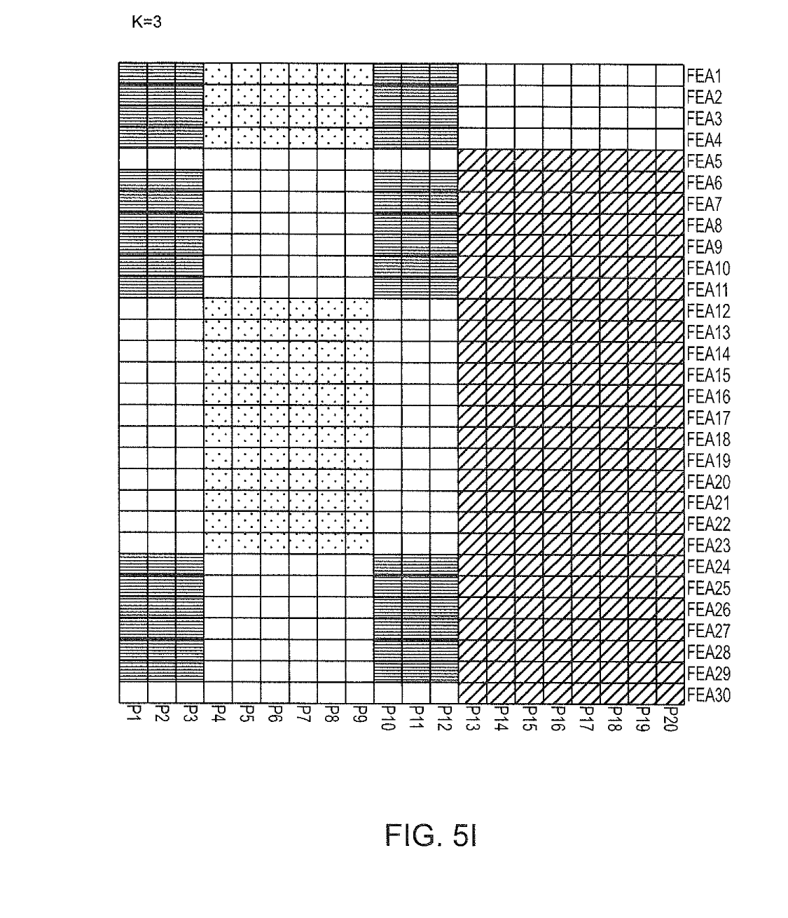

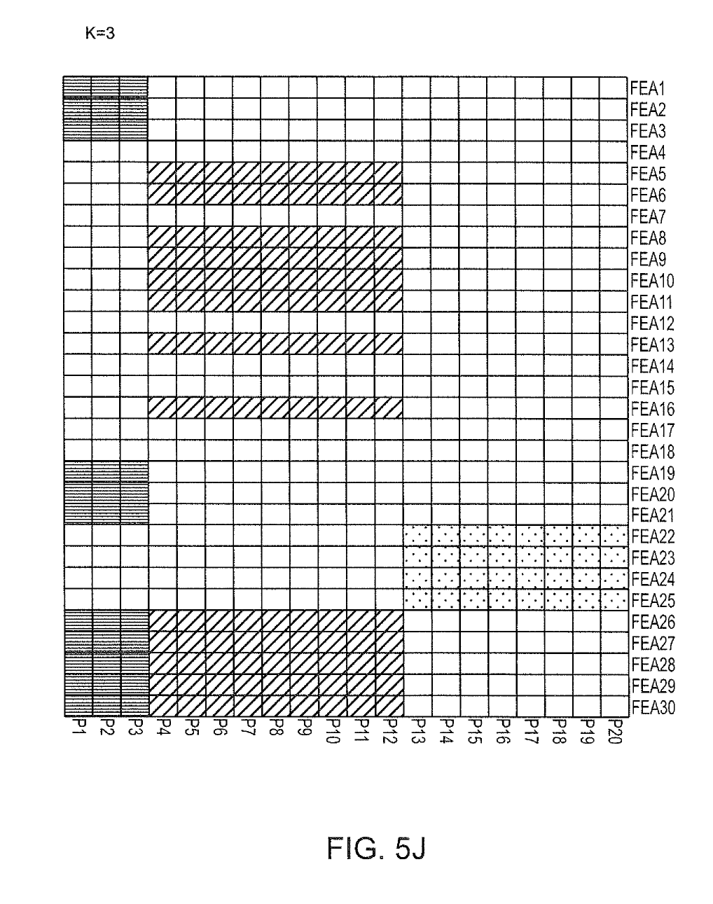

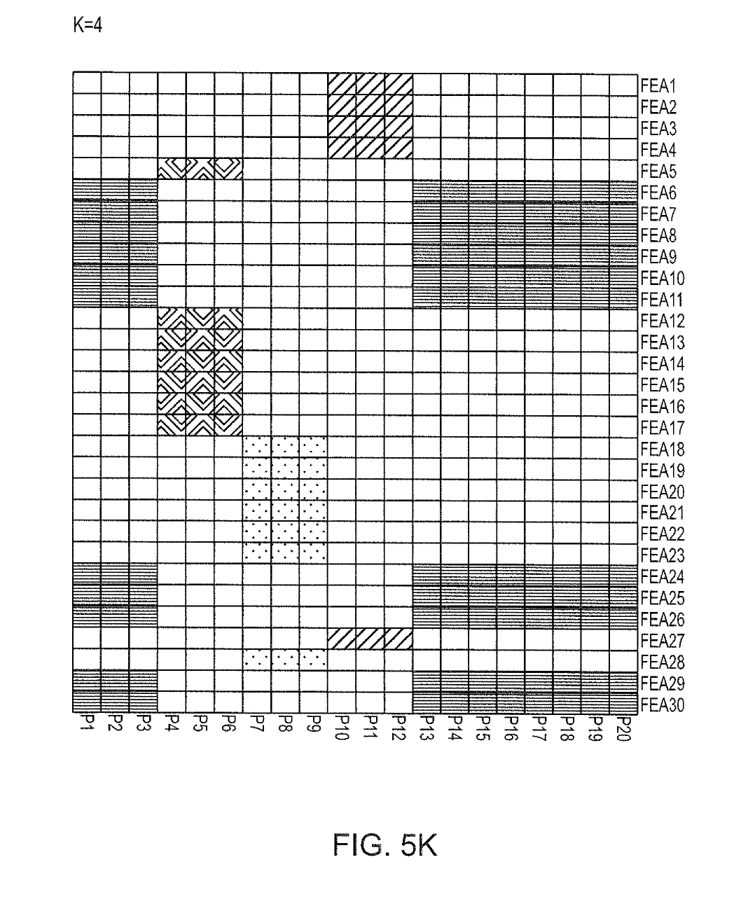

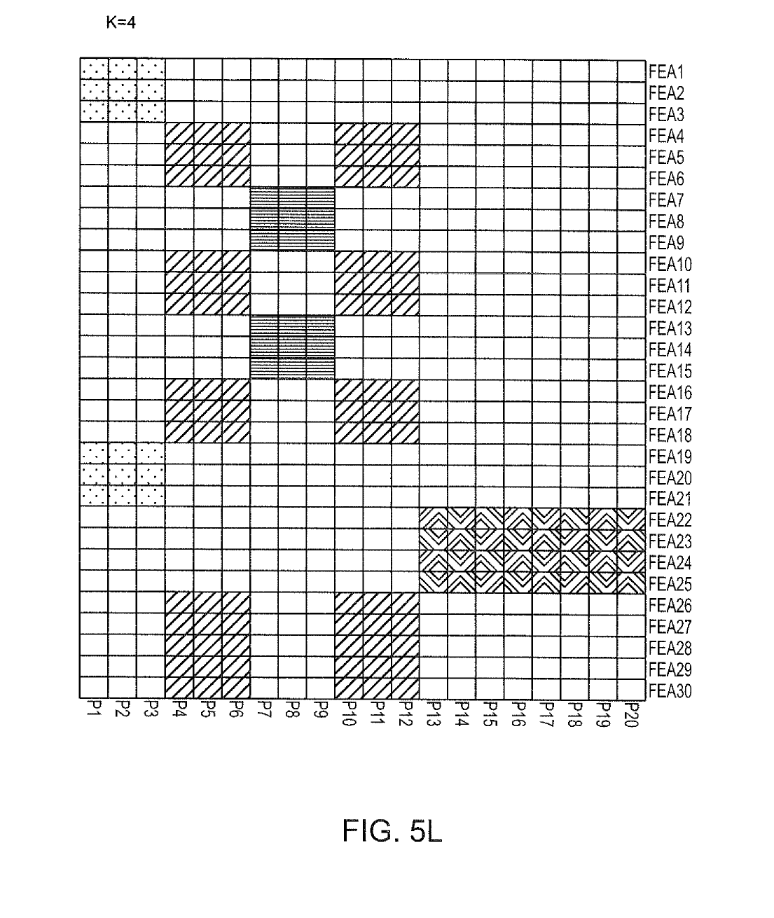

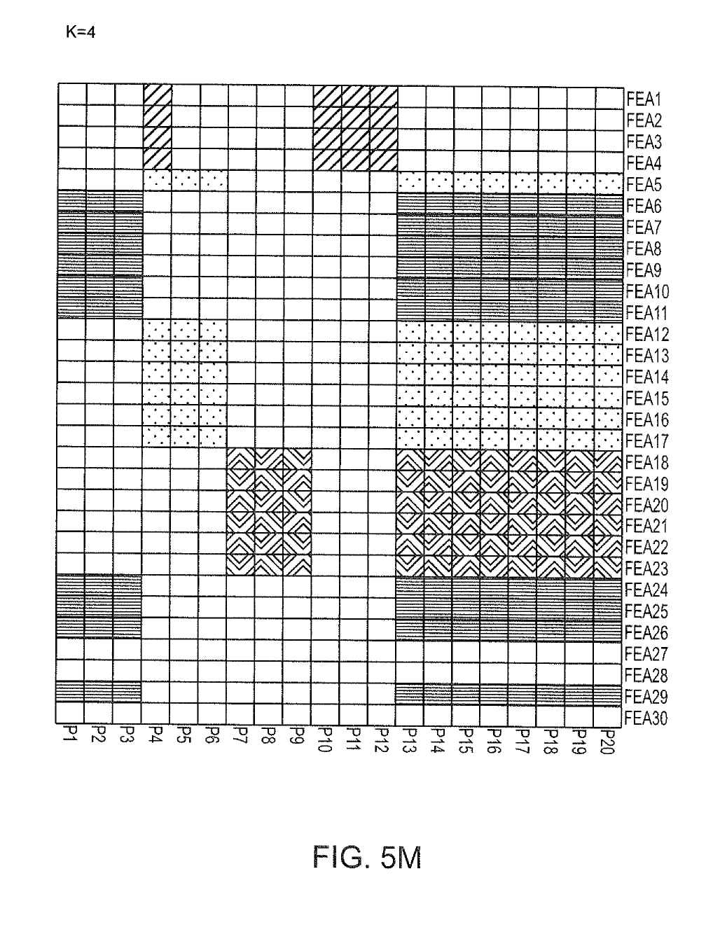

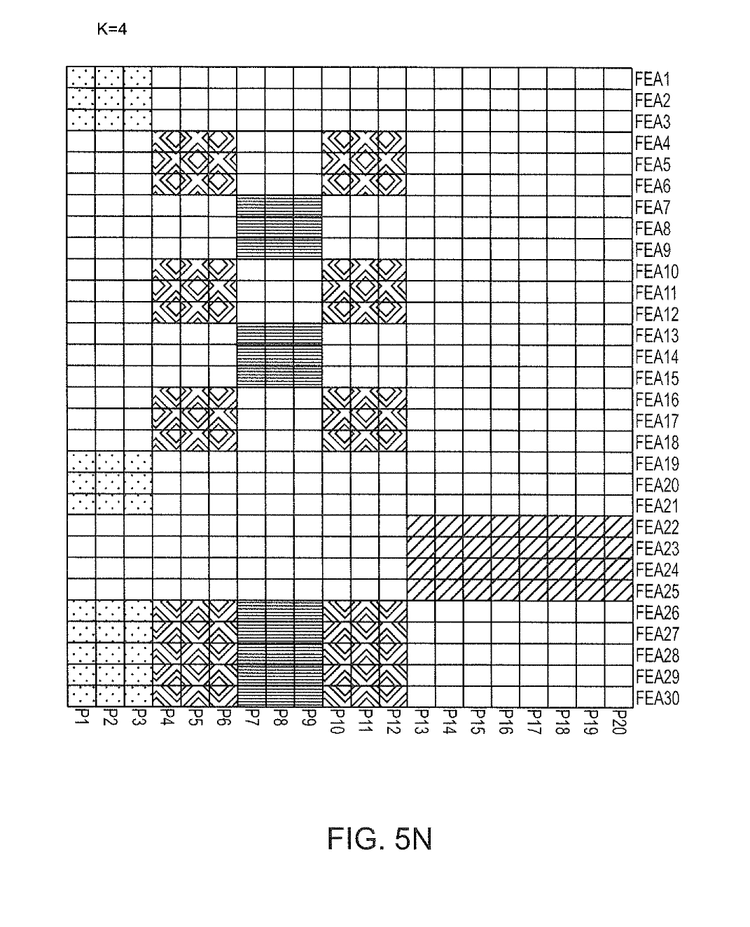

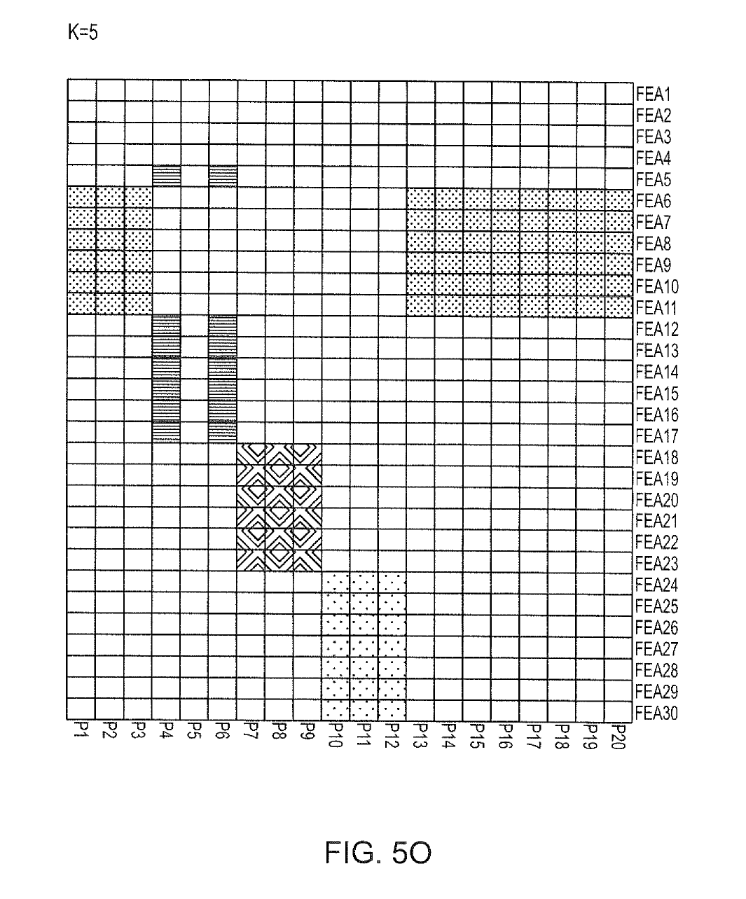

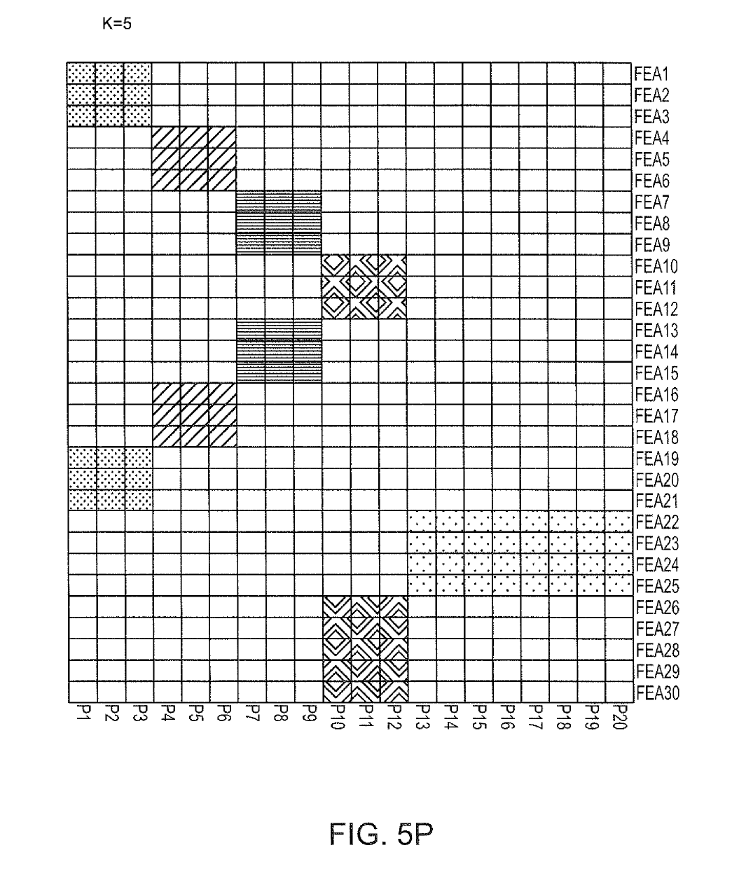

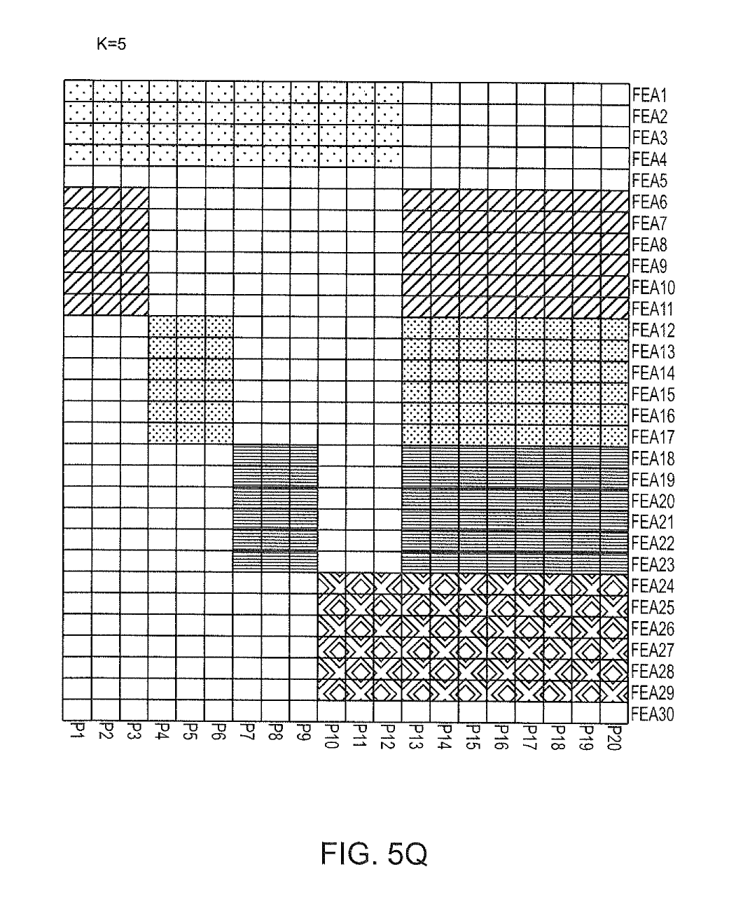

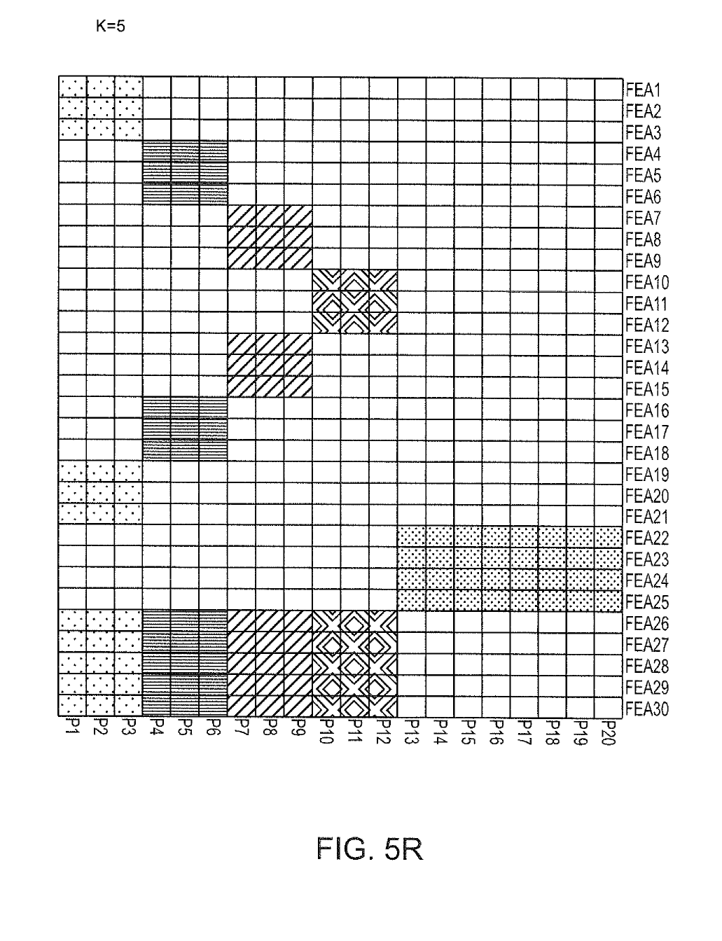

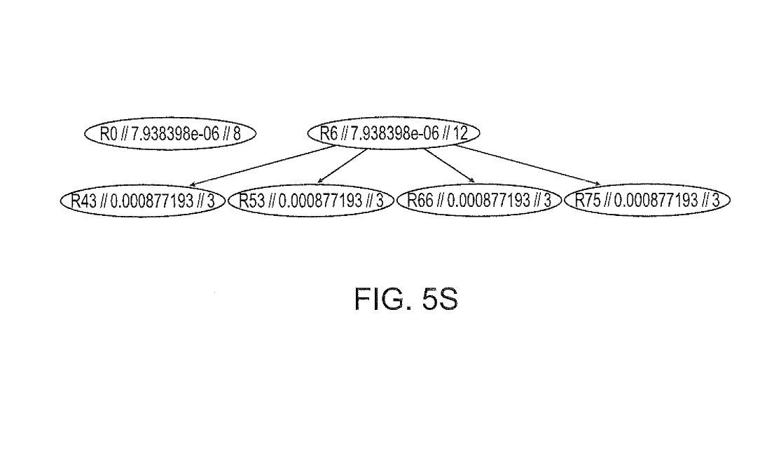

FIGS. 5A-5S provides a synthetic example designed to compare the ability of the bioNMF and FNMF methods to identify pre-defined biclusters with partitions harboring different number of maximum biclusters (k), from 2 to 5. Default bioNMF parameters are applied for both methods, and a fuzziness threshold=0.5 is used for the FNMF method. Each depicted column and row in the synthetic matrices represents subject and features, respectively. The depicted matrix of FIG. 5A comprises 3 crisp biclusters representing genotype data, where the high-valued cells are highlighted. The depicted matrix of FIG. 5B comprises 3 crisp biclusters representing phenotype data, where the high-valued cells are highlighted, where the biclusters are different from those biclusters in the matrix of FIG. 5A. Biclusters defined in both domains have a non-null intersection of subjects. The depicted matrices of FIGS. 5C-5D comprise biclusters corresponding to the matrices of FIGS. 5A-5B and identified by bioNMF with K=2. The identified biclusters are highlighted. The depicted matrices of FIGS. 5E-5F comprise biclusters corresponding to the matrices of FIGS. 5A-5B and identified by FNMF with K=2. The identified biclusters are highlighted. The depicted matrices of FIGS. 5G-5H comprise biclusters corresponding to the matrices of FIGS. 5A-5B and identified by bioNMF with K=3. The identified biclusters are highlighted. The depicted matrices of FIGS. 5I-5J comprise biclusters corresponding to the matrices of FIGS. 5A-5B and identified by FNMF with K=3. The identified biclusters are highlighted. The depicted matrices of FIGS. 5K-5L comprise biclusters corresponding to the matrices of FIGS. 5A-5B and identified by bioNMF with K=4, with the identified biclusters highlighted. The depicted matrices of FIGS. 5M-5N) comprise biclusters corresponding to the matrices of FIGS. 5A-5B and identified by FNMF with K=4, with the identified biclusters highlighted. The depicted matrices of FIGS. 5O-5P comprise biclusters corresponding to the matrices of FIGS. 5A-5B and identified by bioNMF with K=5, with identified biclusters highlighted. The depicted matrices of FIGS. 5Q-5R comprise biclusters corresponding to the matrices of FIGS. 5A-5B and identified by FNMF with K=5, with the identified biclusters highlighted. Hierarchically organized network of FIG. 5S is generated at least in part by inclusion of the observations (subjects) resulting from assembling the outcomes obtained by FNMF from all runs (FIGS. 5E-5F, 5I-5J, 5M-5N, and 5Q-5R) into phenotypic-genotypic simulated relations, and from a relation number, the p-value corresponding to the R_{i,j} test applied to the relation, and the number of subjects in the relation describe each node.

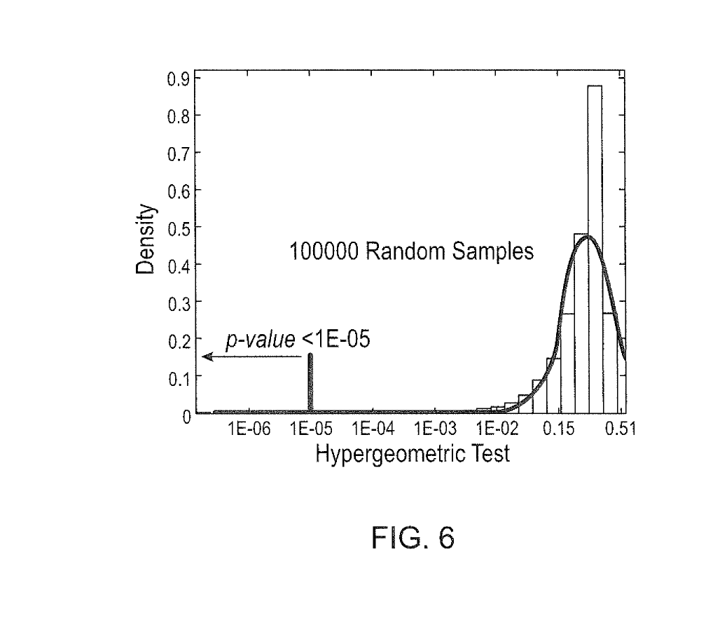

FIG. 6 provides a genome-wide probability of the relations. The depicted probability is estimated by a simulation with 100,000 independent permutations and random assignation of subjects to phenotypic and genotypic biclusters of random size; calculation of PI_{hyp} between randomly assigned biclusters provides an empirical null distribution of PI_{hyp} that was used to calculate the genome-wide p-value of each relation. All optimal relations had empirical p-value ≦1E-05.

Any number of interface designs are possible, as will be appreciated by one of ordinary skill in the art. The following disclosure describes one such design. Generally, to start a job, the user generally provides an indication of same via the user interface, such as by clicking on a button or tab appropriately labeled (e.g., “Send a Job”). Typically, this option appears on a home page and, when selected, causes the web server to display to the client a submission page, where the user may specify, identify or otherwise provide the input files (generally by file upload or other network transfer) and the user's desired parameters, which are generally selected from displayed options or drop-down menus.

After the parameters are specified, the user may begin the job by manipulating the user interface (e.g., by clicking a “Send” or “Go” button). In an embodiment, a contact e-mail address may be provided for notifications and reporting. Though this is generally optional, it is encouraged, as the execution time may be lengthy in certain implementations. If an email address is specified, notifications may be provided, generally at the initiation of the server. Such notifications may comprise a job confirmation, and a job completion notice.

In an embodiment, the server, or a third party computer, may maintain and curate a list of running jobs. Among other things, this facilitates checking on job status. This function may be implemented, by way of example and not limitation, through a web interface, or another interface or protocol.

In an embodiment, the server comprises a tutorial. In another embodiment, the server may also be preloaded with real GWAS example test files. These files may be used in conjunction with the tutorial. This may help new users become comfortable with the process and understanding the inputs. Again, because processing time can be lengthy, it is helpful that the system is configured properly, with the correct inputs, in the first instance, reducing the incidence of unnecessary false starts and re-runs. The tutorial generally comprises instructions concerning which parameters can be altered or configured, ranges for such parameters, and an explanation of the default settings. Default settings are generally preferred for first-time users and beginners (Table 2).

In an embodiment, a SUMA server has one or more parameters related to the biclustering methods, and/or related to the generalized factorization method. In the preferred embodiment, the default basic biclustering method is generally FNMF, with alternative biclustering methods available. FNMF is generally preferred for users who are experienced in biclustering and who understand and are aware of biclustering characteristics (Tables 1-2). In an embodiment, the user interface provides access to or otherwise makes available a list of parameters for each method (Table 3). By way of example and not limitation, this may be done in a help tab. In a further embodiment, the parameter configurations for currently running jobs is also displayed or otherwise made available, also generally by a server computer.

It should be noted that the FNMF biclustering method—which is based on the bioNMF method (20)—introduces the levels of fuzziness as a parameter. This has the advantage of facilitating the generation of more flexible biclusters (i.e., higher values), or more cohesive biclusters (i.e., lower values). In the preferred embodiment, the default value is 0.5.

On the server backend, basic methods (which are repetitively run) may be run as sub-processes of the generalized factorization method, with the minimum and maximum number of clusters (biclusters) specified (e.g., between 2 and \sqrt{n} by default) for each such sub-process.

Another parameter that is preferably specified is the minimum level of coincidence between a phenotype and a genotype biclusters. This affects the quality of the relation between them. Because this matching is calculated by the probability of intersection between two clusters using PI_{hyp}, low values used as a threshold generate fewer, but more cohesive, relations. In contrast, the use of high threshold will admit more relaxed relations—eventually all relations (i.e., p-value=1)—to the hierarchically organized network, and thus, such relations may integrate the risk surface of the disease. In the preferred embodiment, p-value <0.05 is the default threshold.

The web server generally comprises an output page. In the preferred embodiment, the output page comprises a “snapshot” of the analysed GWAS. Generally this snapshot will comprise a visualization, such as one or more graphical output sections. One such section may be a summary panel with information, such as an identification of the input data, and/or the method and parameter selected. This improves the ability the track results. Another such section may be a statistical summary of the run, comprising information such as the total number of identified relations, the average number of subjects, phenotype features, and/or SNPs per relation.

Another such section may comprise a visualization of the network, comprising significant relations hierarchically organized when describing approximately the same target subjects from different phenotype and/or genotype features. In an embodiment, the network visualization is organized without information about the subject status (i.e., unsupervised learning), which is incorporated a posteriori into each relation to calculate its risk. Each node may contain the relation name, its associated risk, and/or the degree of matching between the phenotype and genotype biclusters that originated the relation (PI_{hyp}). Relations may be color-coded by their corresponding risk values.

Another such section may be a chart or graph. In an embodiment, the chart provides a visualization of the risk distribution, such as the distribution among all relations. In a further embodiment, the chart visualization is a bar chart.

Another such section may comprise one or more heatmap visualizations. By way of example and not limitation, a relation-mapping output section may provide two heatmaps, one phenotype and another genotype, where the features (columns) characterizing each relation (rows) are highlighted.

Another such section may comprise one or more classification trees. A classification tree will be understood by those skilled in the art as being an heirarchial visualization of relations. By way of example and not limitation, a classification may tree may be a phenotype tree. Also by way of example and not limitation, a classification may tree may be a genotype tree. In an embodiment, two classification trees are displayed, one representing a genotype tree and another representing a phenotype tree. Generally, it is preferred that features indicated in a classification tree are ordered. For example, such features may be ordered, from top to bottom, by importance as calculated by entropy.

Another such section may comprise a visualization of the risk surface of a disease. Generally, the risk surface is plotted and displayed as a dynamic three-dimensional graph as described elsewhere herein.

Another such section may comprise a list of relations and their corresponding p-values. In the depicted embodiment of FIG. 115, the depicted list shows p-values resulting from the application of the IBS kernel-machine method from the R-project package SKAT. Generally, such results are provided in HTML format for direct visual inspection by the user-agent. Those skilled in the art will understand that the displayed images can generally be downloaded. The user interface will also make available for download the subjacent data in a readily accessible format, such as plain text (e.g., ASCII text).

Another such section may comprise a summary of the inputs to the system, including but not necessarily limited to, an identification of the input files and the method and parameters selected.

The SUMA server may implement one or more novel algorithms. These may be: the basic biclustering FNMF method, an extension of the bioNMF method allowing overlapping and outlier detection of biclusters; a generalized factorization method, which fuses inter-domain biclusters into relations in an efficient unsupervised fashion; and, a data-labeling strategy, which transforms unsupervised latent relations into supervised structures by incorporating their risk in an unbiased manner. The latter strategy facilitates calculating the ranking of the features within a relation as measured by their entropy, as well as to plot a predictive risk surface of the subjacent disease.

The diagnostic use of a SUMA server may be applied separately to both large- and small-scale schizophrenia datasets. These GWA studies were partly carried out in Washington University School of Medicine, harboring typical case-control phenotypes or extended phenotypes, where relatives at risk were also considered. The obtained results empirically demonstrated that genetic risk of schizophrenia occurs along a continuum and that the phenotype-genotype relations are capable of identifying the corresponding intermediate phenotypes shared by patients and their first-degree relatives. Moreover, these relations were independently curated and cataloged by experts (psychiatrist based nosological framework represented by the DSM-IV), who determined that they distinguish positive from negative symptoms of schizophrenia, that, in turn, dissect the disease into paranoid and non-paranoid classes. This suggests that the differential genetic basis of the relations may dictate differential and personalized treatments of the disease.

It should be noted that two types of statistical evaluations (p-values) are reported, namely one for the probability of an intersection (PI_{hyp}) between a SNP set and a phenotype feature set (i.e., the statistical significance of relations) evaluated by the R_{i,j} statistics, and compared with an empirical random distribution of PI_{hyp} used to estimate the upper non-random p-value of an identified relation. Another evaluation was performed for the probability of a SNP set being associated with schizophrenia (i.e., the genome-wide association significance) calculated by the logistic kernel-machine statistics.

The uncovered phenotype-genotype relations at risk using the NMF method in the big dataset provided significant values as evaluated by the PI_{hyp}: 1E-05<p-value <7E-13. Moreover, the set of SNPs included in most of the significant relations were more statistically significant (e.g., p-value<E-05, or even p-value<E-11,) than the best individual SNPs included in the corresponding sets when were evaluated by the SKAT method (i.e., many orders of magnitude lower, Table 5). Similarly, the phenotype-genotype relations from the small dataset obtained the following PI_{hyp} values by using the bioNMF method: 1E-05<p-value <3E-10. Likewise the big dataset, the SNP sets evaluated by the SKAT method displayed better values than the individual SNPs either with the bioNMF (1E-05<p-values <2E-08) or with the FNMF (p-value <1E-05, up to p-values <2E-08) methods (Table 5). This approach reduces the problem of multiple comparisons exhibited by typical GWAS analysis, as expected. It should be noted that, with respect to hypergeometric statistic inequalities, smaller statistics imply superior relationship cohesion, and the inequalities presented are in terms of relationship cohesion, not in terms of the quantity represented by the hypergeometric statistic.

Table 5 provides the statistical significance of 10 of the best SNP sets/relations calculated by the kernel-machine model compared to the average and best SNP values with the set.

TABLE 5

| | | Group | Average SNP | Best SNP |
|---|---|---|---|---|
| | Relation | p-value | p-value | p-value |
| ¹Big Dataset | R88 | 1.43E−11 | 2.06E−03 | 2.15E−07 |
| FNMF | R56 | 1.91E−10 | 4.33E−03 | 2.15E−07 |
| | R59 | 2.32E−09 | 9.48E−03 | 2.38E−05 |
| | R87 | 7.11E−07 | 1.05E−02 | 1.37E−05 |
| | R09 | 1.51E−06 | 2.52E−03 | 1.23E−04 |
| | R25 | 3.49E−06 | 1.67E−03 | 1.11E−04 |
| | R42 | 4.15E−06 | 2.35E−02 | 6.59E−05 |
| | R81 | 1.13E−05 | 2.99E−02 | 2.57E−04 |
| | R75 | 2.61E−05 | 1.37E−02 | 1.02E−04 |
| | R19 | 2.88E−05 | 3.43E−02 | 4.60E−04 |
| Small Dataset | R58 | 1.08E−09 | 8.40E−02 | 3.32E−06 |
| FNMF | R59 | 1.08E−09 | 5.84E−02 | 9.57E−05 |
| | R60 | 1.08E−09 | 8.40E−02 | 1.44E−07 |
| | R62 | 1.08E−09 | 1.02E−02 | 2.57E−06 |
| | R01 | 2.06E−08 | 5.84E−02 | 2.70E−05 |
| | R02 | 2.06E−08 | 3.27E−03 | 3.50E−06 |
| | R03 | 2.06E−08 | 2.33E−03 | 4.32E−06 |
| | R04 | 2.06E−08 | 2.33E−03 | 3.98E−07 |
| | R06 | 2.06E−08 | 1.02E−02 | 6.32E−05 |
| | R07 | 2.06E−08 | 2.80E−01 | 3.35E−06 |
| ¹Small Dataset | R01 | 2.27E−08 | 6.28E−02 | 8.16E−06 |
| bioNMF | R02 | 3.04E−07 | 1.22E−01 | 2.62E−05 |
| | R03 | 2.68E−08 | 4.89E−02 | 3.32E−06 |
| | R04 | 6.32E−05 | 5.13E−03 | 7.60E−04 |
| | R05 | 3.17E−04 | 1.64E−01 | 5.19E−04 |
| | R06 | 3.66E−07 | 1.30E−01 | 2.18E−05 |
| | R20 | 1.30E−07 | 6.13E−02 | 6.05E−06 |
| | R18 | 1.29E−05 | 3.02E−01 | 2.33E−04 |
| | R09 | 1.04E−07 | 6.35E−02 | 1.75E−05 |
| | R10 | 6.16E−07 | 8.73E−02 | 1.75E−05 |

Notably, many of these relations have SNPs located all across the genome—instead of within a gene or haplotype—that are associated with many genes previously related to schizophrenia, as well as with novel ones (e.g., non-coding RNA genes) or to other regulatory features. The found genes have been primarily associated to mental, brain and nervous system disorders as cataloged by the NextBio (www.nextbio.com, scores >80) and Ingenuity Pathways Analysis (IPA) (www.ingenuity.com, p-value <5.2E-05) servers. Moreover, many of the identified genes linked to hypodopaminergic phenotypes form a highly interconnected network that can be parceled out to just a few major functional pathways, encoding almost all essential component in the neuronal cell adhesion (IPA, p-value <3E-05) or in the small GTPase or signaling pathway (IPA, p-value <2E-04). Other mapped genomic regions overlap newly characterized long intergenic non-coding RNAs coincident with an annotated CNV—including the lincRNAs AC068490.2 and AC096570.2, which expression may cause alterations of the normal brain development. Overall, these cohesive relations show that the phenotype-genotype relations are not just a computational artifact, but encode a profound biomedical meaning.

The results obtained with SUMA can easily interact with other servers, programs and databases. For example once identified the SNP-subsets in each optimal relation they can be easily used for downstream analysis such as, but not necessarily limited to, functional annotation; Haploreg webservice; ENCODE (genome.ucsc.edu/ENCODE), and ENSEMBL database (www.ensembl.org); network and pathway analysis: DAVID; Genecards; Prolinks Database 2.0; Ingenuity Pathways Analysis (IPA) (www.ingenuity.com); ICSNPathway; analysis of diseases and drugs related to the affected genes; Nextbio webservice ‘Disease Atlas’ and ‘Pharmaco Atlas’.

The systems and methods described herein may be used to create and maintain one or more a knowledge-based platforms for analysis and diagnosis of diseases and their comorbidity factors. By way of example and not limitation, the systems and methods may be applied to mental disorders comorbid with hypertension and/or cardiovascular diseases. The platforms comprise knowledge-based electronic libraries created from collected studies and transformed into a disease platform including a recommender system. This may assist physicians in the diagnosis and prediction of specific outcomes for prevention or early intervention.

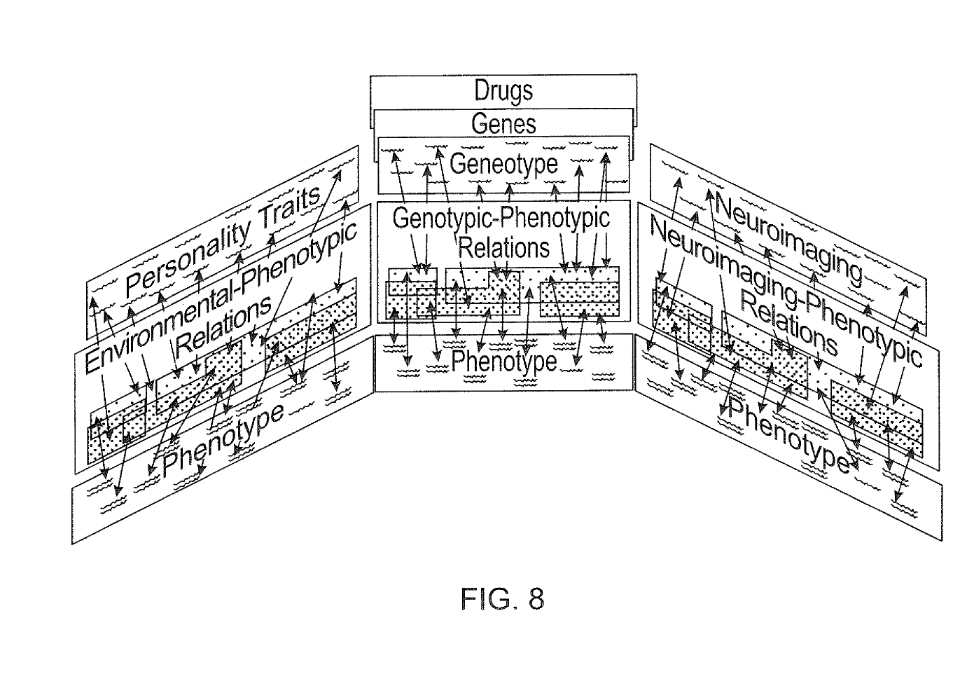

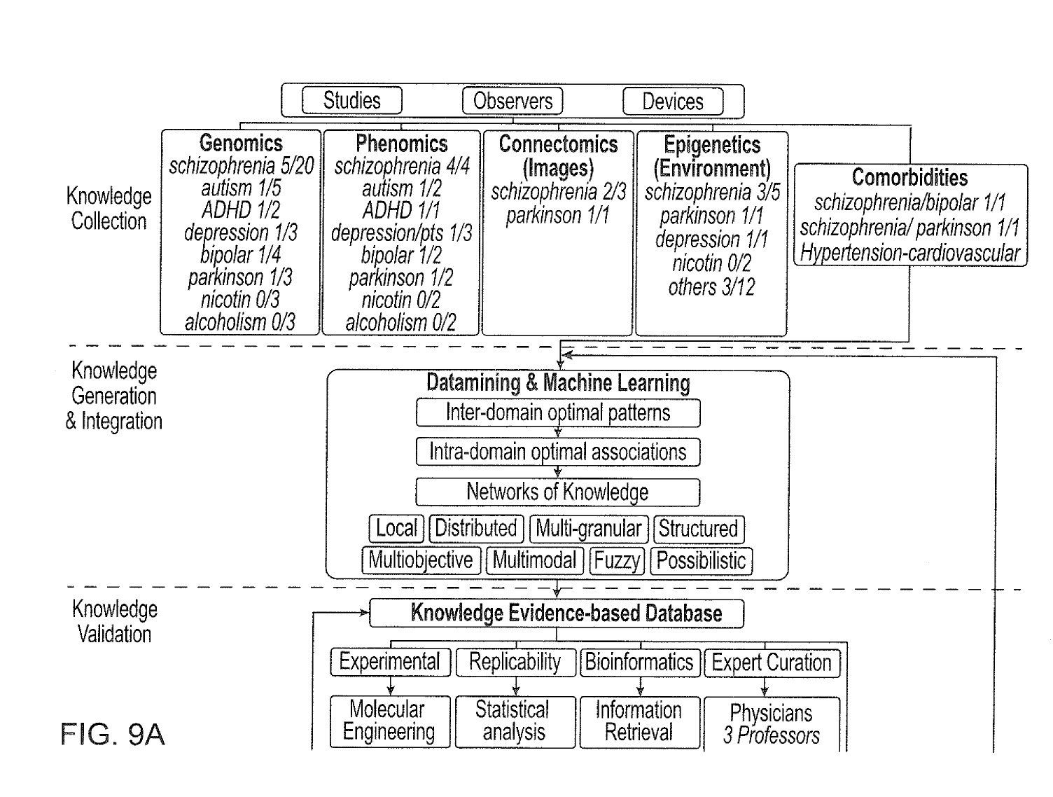

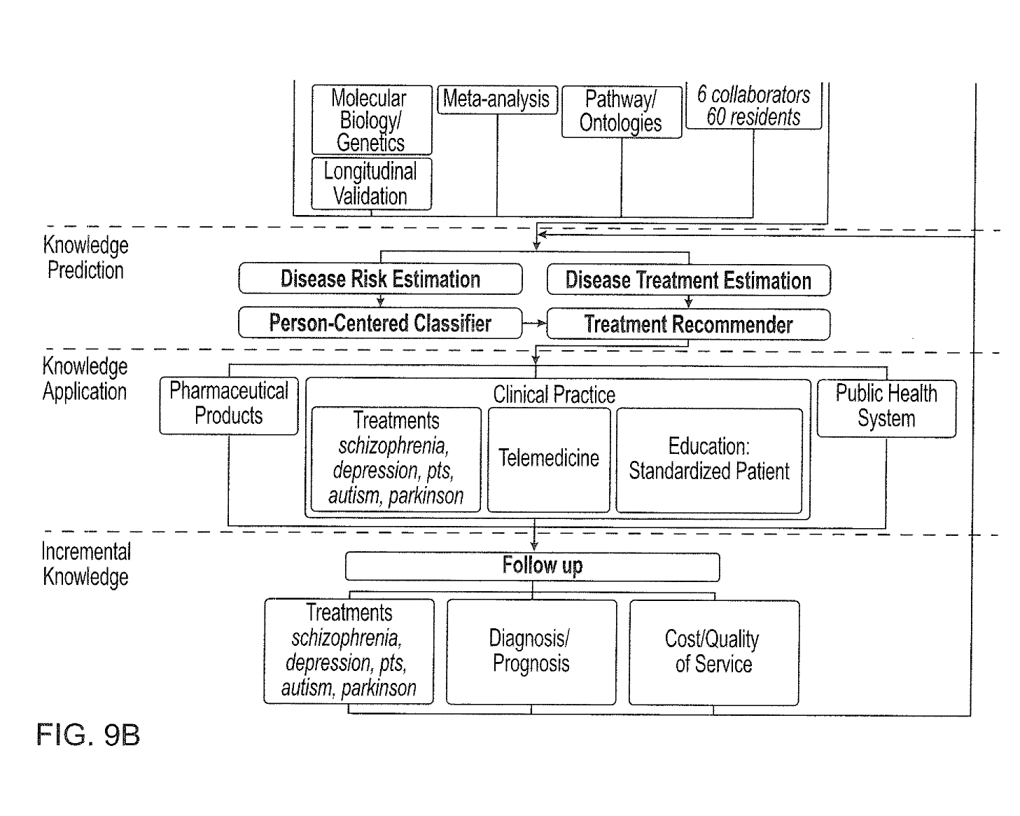

In an embodiment, this may be done by decomposing a disease into a collection of diseases, as a logical “disease” may harbor distinct causal or predisposing genetic variants and/or other biomarkers, despite having similar (but not necessarily identical) imaging or clinical manifestations (phenotypes). These partitions are then cross-correlated, including using the techniques and methods described elsewhere herein, across related diseases (comorbidity) for outcome prediction and/or detection. An embodiment of the logic, and an implementation, are depicted in FIGS. 8 and 9. This may improve person-centered diagnosis and treatment of diseases because distinct classes of affected individuals are likely to respond differentially to particular therapeutic treatments.

The depicted platform of FIGS. 8 and 9 collects and partitions genetic variants from studies (e.g., GWAS, CNVs, personal genome sequences) and disambiguates their related questionnaires into clinical features. It may also relate partitions of genetic variants with genes, and in turn, with diagnosis and targets of drug treatments. In an embodiment, the platform collects and makes compatible additional clinical features, including biomarkers, and partition them into syndromes on a range of severity and differential types. In another embodiment, the platform collects imaging studies and processes them analogously to the genetic studies. In a still further embodiment, the platform, collects and performs personality trait studies and their associations with clinical features to account for the influence of environmental factors and lifestyle behaviors—in addition to genetics—in complex diseases. By way of example and not limitation, one such study is the Temperament and Character Inventory, or “TCI.” In a still further embodiment, the platform processes personality trait studies and their associations with clinical features analogously to the genetic studies). In a still further embodiment, the platform collects and incorporates studies from diseases that are comorbid (e.g., mental disorders and cardiovascular/hypertension diseases). In a still further embodiment, the platform cross-correlates and establishes a model-free analysis of complex diseases based on relationships among clinical, genetic, imaging, biomarker, and environmental patient profiles, to arrive at their predictable risk and possible treatments.

These and other steps are generally carried out using the techniques and methods elsewhere described herein. Such techniques and methods may include, but are not necessarily limited to: the use of: unsupervised data partition of genome, imaging, biomarker, and clinical studies (i.e., without influence of the individual clinical status such as case, control, or relative classification); domain-specific data partitions (within each domain of knowledge: imaging, genetics, clinical status, etc.); unbiased partition relationships among domain-specific partitions (i.e., without priors, and model-free); inter- and intra-disease relationships among partitions.

In an embodiment, the inputs include a text file corresponding to the evaluation of a patient. After the input text has been analyzed and processed according to the techniques and methods described herein, the system provides an output. The output may comprise, among other things, alarms, descriptions and recommendations. The particular output will depend upon, among other things, whether and to what extent the input evaluations match with previous cases, their related genetics, imaging, clinical syndromes, environmental factors, diagnosis and/or drug treatment.

The systems and methods described herein provide accessibility to structured genetic knowledge from studies, decomposition of the clinical questionnaires of these studies into discrete information, homogenization of clinical (phenotypic) language that allow compatible inter- and intra-disease relations and/or studies, and focus on local genetic, imaging, biomarker, clinical, and environmental differential profiles among patients.

Although the description herein is generally with respect to a web server, one of ordinary skill in the art will understand that this disclosure is also applicable to other computer technologies. By way of example and not limitation, a web server is only one possible server implementation implementing one particular protocol family. Other protocols, which necessarily result in other types of computer servers being implemented, are possible, including specialized or proprietary protocols designed for the particular uses described herein. Further, other database structures are also possible, including the use of conventional relationship database management software, and alternative text file formats, including XML and other markup languages. Further, it will be clear to those skilled in the art that the client device may be a personal device, such as a wearable or carrying computer, a mobile phone, a smart phone, a tablet computer, and the like.

The nonnegative matrix factorization method is a statistical data mining technique that constructs approximate factorization of the form V≈WH, where VεR^{m×n}, WεR^{m×k} and HεR^{k×n} are positive matrices where m is the number of variables, n the number of objects, and k the number of factors. The difference between NMF and other methods arises from the constraints imposed on the matrix W and H. NMF constrains the matrices V, W and H to have nonnegative values. NMF does not only provide an effective reduction of the dimensionality but also more interpretable models of the data.

The implementation of the NMF algorithm consists of iteratively updating W and H as follows:

$${W}_{ia} ← {W}_{ia} {\sum }_{μ} \frac{{V}_{i μ}}{{( WH )}_{i μ}} {H}_{a μ} \\ {W}_{ia} ← \frac{{W}_{ia}}{{\sum }_{j} {W}_{ja}} \\ {H}_{a μ} ← {H}_{a μ} {\sum }_{i} {W}_{ia} \frac{{V}_{i μ}}{{( WH )}_{i μ}} \qquad ( 1 )$$

It can be shown that iterations of these updates converge to a local maximum of the following objective function:

$$F = {\sum }_{i = 1}^{n} {\sum }_{μ = 1}^{m} [ {V}_{i μ} {log ( WH )}_{i μ} - {( WH )}_{i μ} ]$$

The original bioNMF biclustering method uses the non-smooth variant of the NMF algorithm (nsNMF). This variant achieves an easier interpretation of the factors (k) due to the intuitive sparse, non-overlapped part-based representation of the data. To build the biclusters, once the W and H matrices are calculated, the method selects the most representative features for each factor. The bioNMF algorithm define as factor-specific rows or columns those rows or columns in the H and W matrices, respectively, that show high coefficients for a given factor, as well as low coefficients for the remainder factors. This is achieved by sorting the rows in W in descending order by their coefficients in a given column, and then, selecting only the first consecutive rows, which highest value in W is the coefficient in that column. This procedure is repeated for each column of W. Analogously, the process is repeated for the H matrix to select the columns. The set of selected rows and columns for each factor define a bicluster.

Generally, the default biclustering method in the SUMA server is a fuzzy variation of the bioNMF biclustering method here named Fuzzy NMF or (“FNMF”), where every column or row can belong to many biclusters or, eventually, to all of them. Besides, it includes a strategy to identify and discard outliers from the biclusters, like a possibilistic clustering method (12,31,32). Unlike the bioNMF biclustering method, FNMF analyzes each factor by selecting the rows or columns with the highest values based on a threshold established as an input parameter that indicates the level of fuzziness (see equation 3 herein). The selection process for one factor takes into account only the values within that factor, being independent from the values of the rest of the matrix.

Generally, the resulting biclusters are determined using two parameters: the first, the sparseness parameter, is inherited from the bioNMF implementation and is used to find sparse structures that better explain the data set. The sparseness parameter is generally ranged in [0-1]. The second parameter, the fuzziness parameter, is added to the bioNMF method, and implemented to allow overlapping among biclusters, where a row or a column can be included in several biclusters, as in a fuzzy clustering method. The control of outliers, where a row or column is not necessarily included in a bicluster, allows the method to behave like a possibilistic clustering approach. The threshold that controls the levels of fuzziness in the unit interval [0-1] specifies which values will belong to a bicluster. Then, the threshold for factor i in the matrix H is calculated as:

Threshold=max(H₁)*(1−fuzziness) (3)

where all values above the threshold will be kept in the bicluster.

The fuzziness parameter is set to 0.5 by default (eqn. 3). Fuzziness and outlier detection are connected features as occurs in possibilistic clustering. Low values of fuzziness generates crisp partitions and emphasizes the detection of outliers; in contrast, high values of fuzziness increments the degree of overlapping, and thus, becomes less sensitive to outliers. Particularly, when the fuzziness is set to 0 only one row and one column belong to each bicluster, whereas if the fuzziness is set to 1, all the rows and columns belong to every bicluster.

The FNMF features may be evaluated in a synthetic example. For example, a set of synthetic examples may be generated to characterize the features of the proposed FNMF method. To do so, a genotype matrix is simulated with 20 columns (subjects) and 30 rows (SNPs). The cells of the matrix pretending to be in a bicluster were initialized to the value 3, and the rest of the positions are initialized to random values 0 or 1. Analogously, a phenotype matrix is simulated with 20 columns (subjects) and 30 rows (features), where the matrix positions pretending to be in a bicluster were initialized to random values between 90 and 100, and the rest of the positions were initialized to random values between 0 and 50. Next, simulations are performed and compared the FNMF with its predecessor bioNMF method, which was utilized with default parameters. The fuzziness parameter for the FNMF algorithm was initialized to 035 due to the small size of the example.

First, a base case (FIGS. 2A-2B) is formulated to evaluate the ability of the biclustering methods to identify crisp bicluster. This base case consists of three pre-defined biclusters reminiscent of a genotype matrix, and another three different biclusters suggestive of a phenotype matrix. Each column in a matrix corresponds to a subject, and each row represents a single feature (i.e., phenotype or SNP features). Both bioNMF and FNMF methods correctly identified the three bicluster in both genotype and phenotype matrices, as expected (FIGS. 2C-2D).

Second, an experiment is designed to test the ability of the methods to identify outliers (FIGS. 3A-3F, outliers are indicated with ellipses). Empty rows and/or columns may be expressly or explicitly introduced that do not belong to any bicluster (i.e., representing outliers). Generally, the bioNFM method assigns empty features or subjects to a bicluster (FIGS. 3C-3D), which is not the case in the FNMF variation (FIGS. 3E-3F). This empirically demonstrates the ability of FNMF, following a possibilistic clustering approach, to avoid the constraint that any observation must belong to at least one bicluster.

Third, the ability of the methods to identify vague dataset is evaluated, where columns and/or rows can belong to various biclusters (FIGS. 5A-5B). Because typical bicluster analysis attempts to obtain crisp partitions of the searching space, a row or column only can belong to the closest bicluster. The bioNMF method assigns overlapped rows, and/or columns, and/or cells (intersection of columns and rows) to one of the possible biclusters, as expected (FIGS. 4C-4D). However, the FNMF variant includes overlapped data in more than one bicluster (FIGS. 4E-4F), encoding the uncertainty inherent to the data.

Although there are many indices that estimate the appropriate number of clusters for a given partition, they are often constrained by the type of bicluster and metrics utilized. Therefore, it is difficult to obtain a consensus from them all and they may provide contradictory results. Moreover, given that the target of the method is to obtain good relations among biclusters from different domains of knowledge, it is not known which bicluster in one domain will match another bicluster in a different domain. Thus, the more varied the biclusters are, the better the chance of identifying posterior inter-domain relations. To do this, a basic biclustering method is applied in one domain of knowledge to generate multiple biclustering results using various numbers of bicluster initializations (from 2 to \sqrt{n}, where n is the number of observations/subjects).

Formulation of the learning clustering problem as described above could result, by itself, in general relations describing a large number of subjects based on few features, as well as specific relations describing few subjects with a large number of features. Because a clustering process in phenomics uses both explanatory and exploratory processes (1), it is not unreasonable to keep—instead of discard—nested relations. This is because flexible relations tend to be more sensitive and have higher predictive power, whereas homogeneous relations tend to be more specific and thus more sensitive to misclassifications. Therefore, to provide descriptions of subjects from different points of view (multiobjective and multimodal clustering optimization), both general and specific descriptions may provide useful information to establish the risk of a disease.

The utilized clustering method differs from the family of standard unsupervised pattern-recognition procedures. Instead of defining clusters as subsets of the dataset where each pair of points is selected on the basis of pre-specified notions of distance or similarity, this method looks for cohesive subsets meeting certain constraints imposed by the ability of each subset (cluster) to establish relations with other clusters independently defined in a different domain of knowledge. R_{i,j} “good” relational clusters can be identified by optimizing a functional based on the probability of intersection between pairs of clusters defined in different domains, instead of the typical inner and intra-clustering metrics. In essence, the method searches for good and cohesive clusters instead of good clustering partitions.

Consider a synthetic example of the multi-biclustering approach and its summarization into organized inter-domain relations. Such a synthetic example may be designed to test the ability of the basic methods to identify good biclusters when the correct number of bicluster is unknown (FIGS. 5A-5B), which is often the case in data analysis. Big size biclusters tends to encode many subjects described by few features, and thus, becoming more sensitive to detect or predict unseen observations by similarity. In contrast, small size biclusters tends to harbor few well-described observations, and thus, are more specific. Remarkably, the small biclusters identified by our method are no necessarily subpartitions of the big bicluster like in typical hierarchical clustering methods, because they can be generated in a different partition based on a distinct maximum number of bicluster.

The biclusters generated with different number of bicluster (k) between 2 and 5 (FIGS. 5C-5L) by using the NMF and the FNMF methods may be analyzed, and the results obtained by NMF with different k values reveal the difficulties of using this method to uncover coherent bicluster in terms of maximizing the number of rows and columns within a bicluster that resembles the original data (FIGS. 5C-5D, 5G-5H, 5K-5L). This may be due to running the method with the incorrect number of bicluster, because those results obtained with k=5 (FIGS. 5O-5P) seem to be more adequate. However, even if the number of biclusters is appropriate, some high-valued cells were not included in the resulting bicluster (FIGS. 5O-5P). The FNMF, by combining the sparseness and fuzziness parameters, is more sensitive to maximize the number of observations within biclusters that resemble the original data (FIGS. 5E-5F, 5I-5J, 5M-5N, 5Q-5R), as seen by the compact identification of big blocks of data (i.e., big bicluster).

Finally, the relational clustering approach described herein provides a way of independently testing which are good biclusters, despite the partition and maximum number of biclusters where they were generated. To do so, the algorithm uses a co-cluster test based on R_{i,j} statistics (see equation 4 herein), where the coherence between two bicluster is evaluated by their common observations. Then, coherent bicluster are encoded as relational bicluster or simply relations.

The results obtained by FNMF are summarized in a hierarchically organized network by inclusion of the observations (subjects) captured by the relations (FIG. 5S). The relations R0 and R6 integrate the highest level in the hierarchy, where the relations harbor biclusters identified with a maximum of 2 bicluster. The second level of detail includes four different relations (R43, R53, R66, and R75) identified with a maximum of 5 bicluster, and describing subsets of subjects in R6 from different points of view (i.e., different features). The R0 relation does not have further specific explanations.

R_{i,j} statistics may be used as a relationship (co-clustering) metric. The degree of matching between two bicluster (co-clustering) may be assessed by calculating the pairwise probability of intersection among them based on the R_{i,j} distribution (PI_{hyp}):

$${PI}_{hyp} ( {P}_{i} , {G}_{j} ) = 1 - {\sum }_{q = 0}^{p - 1} ( \begin{matrix}h \\ q\end{matrix} ) ( \begin{matrix}g - h \\ n - q\end{matrix} ) / ( \begin{matrix}g \\ h\end{matrix} ) \begin{matrix}h = \vert {P}_{i} \vert \\ n = \vert {G}_{j} \vert \\ p = {P}_{i} ⋂ {G}_{j}\end{matrix} \qquad ( 4 )$$

where p observations belong to a set Pᵢ of size h, and also belong to a set Gⱼ of size n; and g is the total number of observations. Therefore, the lower the PI_{hyp} value, the higher the overlapping, and thus, of the better co-cluster coincidence.

Jaccard's similarity measurement may be used as an hierarchical clustering organizational metric. The Jaccard metric is here used to measure the degree of inclusion between two relations. Given two relations or bicluster, this metric is defined as the size of the intersection of the two sets divided by the size of their union:

J(A,B)=A∩B/A∪B>δ (5)

where δ represents the 50% of the maximum number of subjects in either A or B.

The discovered phenotype-genotype relations may be used to calculate the risk function of a disease by encoding each relation into a 3-tuple (X,Y,Z), where X and Y correspond to the phenotype and genotype dimensions of the relation, and Z is the risk variable calculated by a weighted average of epidemiological risks of all subjects in the relation (18,19):

$$Risk ( {R}_{j} ) = {\sum }_{∀ i ∈ ST} \vert {ST}_{i} \vert {W}_{i} / {\sum }_{∀ i ∈ ST} \vert {ST}_{i} \vert \qquad ( 6 )$$

with ST being the status of the instances (e.g., cases and controls, or cases, relatives and controls), and W being the weights given by epidemiologic risk of the disease in each relation (e.g., 0 for controls, and 1 for cases, or 0.01 for controls, 0.1 for relatives, and 1 for cases). Relations were placed along the phenotype dimension (x-axis) by clustering them using a phenotype distance matrix. This matrix is composed of all phenotype distances between pairs of relations. Phenotype distance between two relations is again computed using the PI_{hyp} between their corresponding sets of recognized phenotypic features. Relations were placed along genotype dimension (y-axis) by clustering them using a genotype distance matrix. This matrix and the genotype distance were computed as described above for the phenotype using the genotype features. The surface may be interpolated mathematically or programmatically, such as by using third party packages. In the depicted embodiment, the package tgp in R-project is used for interpolation. Similarly, the plotting implementation may be a third party package. In the depicted embodiments, the package latticeExtra was used, also from R-project.

Several uncovered relations may not be genuine. Permutation testing may be performed to select only the most significant relations. To do so in the depicted embodiments, 100,000 independent permutations were generated as following: a) assign random subjects to a phenotypic bicluster of random size; b) assign random subjects to a genotypic bicluster of random size; c) calculate PI_{hyp} between the two bicluster and accumulate the value. These values form an empirical null distribution of PI_{hyp} that is used to calculate the empirical p-value of an identified relation. All optimal relations resulted with an empirical p-value of ≦1E-05.

To calculate the statistical significance of the genotype features (SNP set) of a particular relation, the labeling process is first run, which transforms an unsupervised relation into a supervised relation. Next, the significance of the corresponding SNP set may be estimated. This may be done using, for example, the R-project package SKAT. An independent run of each relation may be performed, since its SNPs can be overlapped with another relation. Particularly, the IBS kernel-machine may be preferably utilized, instead of the weighted IBS kernel-machine, because the genetic variants here used are common (not rare). The sex and ancestry of the subjects may be used as covariates. The remaining parameters may be set as defaults.

Alternative biclustering methods may be used. To provide biclustering analysis methods for different type of input data, for example, Fabia, Cheng and Church, and FLOC methods may be implemented in a SUMA server. However, the NMF based biclustering methods (bioNMF and FNMF) are generally preferred for phenotype-genotype data.

Biclustering by “Factor Analysis for Bicluster Acquisition” (FABIA) is a model-based technique for biclustering, clustering rows and columns simultaneously. Biclusters are found by factor analysis where both the factors and the loading matrix are sparse. FABIA is a multiplicative model that extracts linear dependencies between samples and feature patterns. It captures realistic non-Gaussian data distributions with heavy tails as observed in gene expression measurements. FABIA utilizes well-understood model selection techniques like the EM algorithm and variational approaches and is embedded into a Bayesian framework. FABIA ranks biclusters according to their information content and separates spurious biclusters from true biclusters.

Biclustering based on the framework by Cheng and Church searches for sub-matrixes with a score lower than a specific threshold in a standardized data matrix.

The FLexible Overlapped biClustering algorithm (“FLOC”), defined by Yang et al, can discover a set of possibly overlapping k biclusters with constant rows.

An exemplary usage of SUMA with respect to GWAS analysis of schizophrenia datasets illustrations the systems and methods described herein.

Phenotype-genotype relations encoded in the Gain and NonGain SZ studies of schizophrenia were investigated, which are case-control coherent studies performed in a single lab under similar conditions. This study contains data from 8,023 subjects, 4,196 patients and 3,827 controls, combining data from Euro-American ancestry and African-American ancestry.

The phenotype data for the study was obtained by analyzing the phenotype text files. Because phenotype data differs between cases and controls, the phenomic analysis was performed only for cases to uncover latent sub-types of schizophrenia concealed in a broad classification of subjects as “patients or cases”. All analyzed variables were coded as categorical, most of which only had two possible values. Those variables with multiple values were recoded as binary variables (real values are also accepted), where each one represents a value of the original variable. The phenotype data was encoded in a matrix, where each cell can take three possible values: 1 for “variable=absent”, 2 for “variable=present”, and 0 for a missing value.

Genotyping was carried using the Affymetrix 6.0 array, which assays 906,600 SNPs. This is study was originally performed in part at Washington University, taken as a base for the current studies. A total of 209,321 SNPs were excluded due to these restrictions from the 906,109 SNPs genotyped, therefore, 696,788 passed the quality control filters. Before the identification of SNP sets, a pre-selection of SNPs was performed using the logistic association function included in the PLINK software suite, and the sex and ancestry as co-variables. 2891 SNPs were selected with p-value <0.005. Genotype SNP sets, and their corresponding risk was calculated using all cases and control subjects. However, phenotype-genotype relations were calculated only based on cases (see above).

Study population, ascertainment, phenomics and genomic datasets, as well as other information relative to this study can be accessed in the dbGaP web page [http://www.ncbi.nlm.nih.gov/gap/] by their identifiers: phs000021.v3.p2 and phs000167.v1.p1 for GAIN and NonGAIN projects, respectively. By applying SUMA to this dataset, phenotype-genotype relations (1E-05<p-value <7E-13) at high risk (>70%) are uncovered, some of which were disjoint from the others in the phenotype and/or genotype domains, empirically verifying the multigenic nature of the disease.

The SNPs included in most of the significant relations were more statistically significant as a set (e.g., p-value<E-05, or even p-value<E-11,) than typical GWAS associations based on the individual SNPs (i.e., many orders of magnitude lower). This demonstrates that the phenotype features from those significant relations encode cohesive diagnostics rules based on positive an/or negative symptoms of schizophrenia that, in turn, dissect this complex disease into sub-classes such as paranoid and non-paranoid schizophrenia, and thus, may determine differential drug treatments.

Another example usage of the SUMA web server is in a study of non-medicated cases, relatives at risk and controls. Schizophrenia is a neurodevelopmental disorder with adult onset of symptoms. The hypothesis that a primary dopaminergic deficit underlies vulnerability to schizophrenia was tested. Morphological and behavioral markers of dopaminergic function and genetic profiles correlate with the risk status of a cohort drawn from a medication naïve indigenous population, which included schizophrenic patients, their first degree relatives and unaffected individuals. 35 subjects with chronic, never-treated schizophrenia, 35 unaffected relatives and 35 matched controls, were blindly assessed for motor function, cognitive performance and personality traits. Transcranial ultrasound of the substantia nigra and a genome wide scan were also obtained in each participant. This study is being carried out between the Departments of Psychiatry in University of South Florida and Washington University.

Relations of participants were identified, who shared behavioral and morphological measures connected to groups of participants who shared common genetic profiles (see the relations uncovered in the example proposed in the SUMA web server, p-value <1E-05, up to p-values <3E-10, bioNMF method, FIG. 6). The elements of the behavioral assessment that determined group membership and predicted risk status were known hallmarks of dopaminergic functional loss. Significant homologies were found between groups parsed on the basis of shared behavioral and morphological measures and groups identified on the basis of shared genetic markers, supporting a complex association between genotype and phenotype in this sample predictive of schizophrenia risk.

Joined phenotype and genotype information predicted clinical status and also reliably discriminated affected from at-risk subjects in a separate sample, suggesting that our finding generalize to the entire population. Finally, genes related to clinical status represent overwhelmingly four molecular networks, a number of which have been previously shown to be associated to schizophrenia. For example, genes related to hypodopaminergic phenotypes form a highly interconnected network that can be parceled out to just a few major functional pathways. Notably, every essential component in the small GTPase signaling pathway in a separate network was found, among others.

A family of hypodopaminergic phenotypes is associated with schizophrenia. These phenotypes are associated with complex genotypes, and the combination of genotype and phenotype information is predictive of risk status in a sample containing healthy subjects, unaffected relatives and patients with schizophrenia. As subjects share increasingly more genotypes at SNPs and more hypodopaminergic features, they become increasingly more likely to have schizophrenia. Therefore, genetic risk may act primarily by modulating dopaminergic pathways vulnerability to environmental or epigenetic factors.

Regarding the study population, rural communities of Jujuy (Argentina) were surveyed using primary care agents. Cases of untreated psychosis were notified to the provincial epidemiology system, and free treatment was offered independently.

Regarding ascertainment, subjects were interviewed with Schedules for Clinical Diagnosis in Neuropsychiatry Version 2.1 (SCAN, WHO); interviews were videotaped and re-scored blindly; categories of Diagnostic and Statistical Manual of Mental Disorders, 4th edition (DSM-IV) were obtained by computer algorithms (I-Shell 2.1). Rater disagreement led to a third revision. Subjects with DSM-IV schizophrenia were included as index subjects if one unaffected sibling or parent agreed to participate. Healthy volunteers matched by ethnic background, age, sex, and education to minimize the risk of population stratification, were also interviewed with SCAN. Subjects were assigned a code number written in a wrist band, and all subsequent evaluations were performed by raters blind to their diagnostic status.

Following ascertainment, the index subject, his/her relative and matched control were received in the study area by a study coordinator, assigned a number composed by a sequential string with the last digit randomly adjudicated (three numbers placed in a container and drawn after shaking). Subject identification numbers were written in colored wristbands and the entire assessment (movement disorder, neuropsychological assessment, and ultrasound) was carried out by evaluators blind to diagnosis. All phenotype variables were checked for data quality and distributional normality, and were log-transformed when excessive kurtosis was detected. Descriptive statistics of the cleaned phenotype variables were obtained by univariate analysis. The phenotype assessment includes:

Videotapes obtained following standard guidelines were evaluated blindly by two movement disorder specialists using the Unified Parkinson's Disease Rating Scale motor subscale (UPDRS part 3).

Using a Micromaxx system (United Medical Systems, San Jose, Calif.) with a 1.9 MHz transducer (P17-1-5 probe), examinations of substantia nigra were performed through a preauricular acoustic bone window. Quantification of echogenic area was carried out on saved images by a blind evaluator using a region of interest approach, measured for each side separately (37).

A neuropsychological battery was designed to measure cognitive functioning with as much independence as possible from the subject's language mastery and literacy. Core tests have been used successfully in transcultural studies. The following tests are included:
a. Five Digit Test. An alternative form of the Stroop test based on just five number-words, equally appropriate for subjects from very different social and cultural backgrounds (38).
b. Oral Trails Test. The oral form of the Trail Making Test based on the iterative naming of few items and mental counting; it measures speed of production, visual search, and mental search performance (38).
c. Wisconsin Cart Sorting Test (WCST). A well-established measure of executive function.
d. Raven's Progressive Matrices. A widely used nonverbal intelligence test.
e. Spatial Span. A modified version of the Corsi block-tapping Test (39). It measures visual working memory and attentional capacity in the visual modality.
f. Luria Manual Sequences and Purdue Pegboard Task. Two simple tasks that provide semi quantitative information to distinguish primary motor from planning and executive dysfunction, and are sensitive to prefrontal dysfunction (40).
g. Temperament and Character Inventory (TCI). A self-report measure with high reliability and validity. TCI has been translated and validated in our sample (19,28).

Genotyping was carried out as described above for the large-scale study, where a pre-selection of SNPs was performed using the logistic association function included in the PLINK software suite (26), and 8007 SNPs were selected with a relaxed p-value <0.05. Chromosome wise bulk download of data for all the four populations (CEU, CHB, JPT and YRI) from the HapMap project was performed and the overlapping set of SNPs with the Kolla population were identified (n=9137). MAF of these SNPs was compared with the allele frequency obtained from the Kolla control samples. A comparison of the allele frequency across chromosome in this preliminary analysis suggests that the Kolla population may be similar to the CHB and the JPT compared to the Caucasian population. Most notably, the proportion of informative SNPs was not different in the Kolla and the HapMap.

Although this disclosure is generally made with reference to an exemplary embodiment using genotype data to identify genetic causes of disease and provide diagnostic patient care, other implementations are specifically contemplated which may capture and other types of information. By way of example and not limitation, the systems and methods described herein are suitable for compatibilization of studies from different diseases and identification of factors affecting interactions, comorbidities, among multiple diseases. Also by way of example and not limitation, the systems and methods described herein may be used in an embodiment to identify subclasses of a single disease and/or comorbidities of the disease, and/or the subclass(es) of the disease, with other diseases and/or subclasses of other diseases.

In another embodiment, the systems and methods may be used to identify the evolution of patients using real time measurements. By way of example and not limitation, such measurements may be of biometric data or other measurements taken through physiological monitoring (e.g., via Phillips monitors, cardiovascular monitors, respiratory monitors, medicines, imaging devices, sensors, etc.). In particular, it is contemplated that the systems and methods are suitable for use in intensive care units (“ICU”), hospital sections, telemedicine, and for detection of alarms (e.g., mechanical alarms produced by medical monitoring equipment when dangerous values are detected) and prediction of risk. In another embodiment, the systems and methods may use imaging analysis and diagnostic data as study data. Any data may be compared with the phenotype, including but not necessarily limited to: genetic data; clinical data; demographic data; imaging data; personality data; temporal data, such as temporal series and FMRI images; real-time data, such as waveforms and signals provided by medical devices, including but not limited to monitors and other time-dependent continuous signals; steaming data, including but not limited to images, video, audio, and other multimedia data; any other data that may be generated, collected, observed, transformed, or reported by a medical device or monitor related to a disease or medical condition.

In another embodiment, the systems and methods may be used for characterization, risk evaluation, and admission of patients to emergency room and/or other hospital areas and decision making about derivations (surgery, ICU, home, etc).

In another embodiment, the systems and methods may be used in non-medical risk analyses. By way of example and not limitation, such non-medical risk analyses include economics, social networking problems, or any other potential problem characterized by risk analysis, such as actuarial sciences and underwriting. The fundamental analysis holds, and inputs generally will change to represent to the particular field. By way of example and not limitation, in economics, rather than generate a risk surface using phenotype and genotype data, the risk surface may generated using individual income tax rates and overall treasury revenues.

While the inventions have been disclosed in connection with certain preferred embodiments, this should not be taken as a limitation to all of the provided details of any invention. Modifications and variations of the described embodiments may be made without departing from the spirit and scope of any invention herein disclosed, and other embodiments should be understood to be encompassed in the present disclosure as would be understood by those of ordinary skill in the art.

References, the contents of all of which are herein incorporated by reference.
Houle, D., Govindaraju, D. R. and Omholt, S. (2011) Phenomics: the next challenge. Nat Rev Genet, 11, 855-866.
Holliday, E. G., McLean, D. E., Nyholt, D. R. and Mowry, B. J. (2009) Susceptibility locus on chromosome 1q23-25 for a schizophrenia subtype resembling deficit schizophrenia identified by latent class analysis. Archives of general psychiatry, 66, 1058-1067.
Wang, Y., Gjuvsland, A. B., Vik, J. O., Smith, N. P., Hunter, P. J. and Omholt, S. W. (2012) Parameters in dynamic models of complex traits are containers of missing heritability. PLoS Comput Biol, 8, e1002459.
Wu, M. C., Kraft, P., Epstein, M. P., Taylor, D. M., Chanock, S. J., Hunter, D. J. and Lin, X. (2010) Powerful SNP-set analysis for case-control genome-wide association studies. American journal of human genetics, 86, 929-942.
Yang, J., Benyamin, B., McEvoy, B. P., Gordon, S., Henders, A. K., Nyholt, D. R., Madden, P. A., Heath, A. C., Martin, N. G., Montgomery, G. W. et al. (2010) Common SNPs explain a large proportion of the heritability for human height. Nat Genet, 42, 565-569.
De, S. and Babu, M. M. (2010) A time-invariant principle of genome evolution. Proc Natl Acad Sci USA, 107, 13004-13009.
Wu, M. C., Lee, S., Cai, T., Li, Y., Boehnke, M. and Lin, X. (2011) Rare-variant association testing for sequencing data with the sequence kernel association test. American journal of human genetics, 89, 82-93.
Ward, L. D. and Kellis, M. (2012) HaploReg: a resource for exploring chromatin states, conservation, and regulatory motif alterations within sets of genetically linked variants. Nucleic Acids Res, 40, D930-934.
Kupershmidt, I., Su, Q. J., Grewal, A., Sundaresh, S., Halperin, I., Flynn, J., Shekar, M., Wang, H., Park, J., Cui, W. et al. (2010) Ontology-based meta-analysis of global collections of high-throughput public data. PloS one, 5.
Zhang, K., Chang, S., Cui, S., Guo, L., Zhang, L. and Wang, J. (2011) ICSNPathway: identify candidate causal SNPs and pathways from genome-wide association study by one analytical framework. Nucleic Acids Res, 39, W437-443.
Flicek, P., Amode, M. R., Barrell, D., Beal, K., Brent, S., Chen, Y., Clapham, P., Coates, G., Fairley, S., Fitzgerald, S. et al. (2011) Ensembl 2011. Nucleic Acids Res, 39, D800-806.
Bezdek, J. C. (1998) In Pedrycz, W., Bonissone, P. P. and Ruspini, E. H. (eds.), Handbook of Fuzzy Computation. Institute of Physics, Bristol, pp. F6.1.1-F6.6.20.
Zwir, I., Huang, H. and Groisman, E. A. (2005) Analysis of Differentially-Regulated Genes within a Regulatory Network by GPS Genome Navigation. Bioinfonnatics, 21, 4073-4083.
Zwir, I., Shin, D., Kato, A., Nishino, K., Latifi, T., Solomon, F., Hare, J. M., Huang, H. and Groisman, E. A. (2005) Dissecting the PhoP regulatory network of Escherichia coli and Salmonella enterica. Proc Nati Acad Sci USA, 102, 2862-2867.
Romero-Zaliz, R., Del Val, C., Cobb, J. P. and Zwir, I. (2008) Onto-CC: a web server for identifying Gene Ontology conceptual clusters. Nucleic Acids Res, 36, W352-357.
Ruspini, E. H. and Zwir, I. (2002) In Pal, S. K. and Pal, A. (eds.), Pattern recognition: from classical to modern approaches. World Scientific, New Jersey. 454-474.
Tavazoie, S., Hughes, J. D., Campbell, M. J., Cho, R. J. and Church, G. M. (1999) Systematic determination of genetic network architecture. Nat Genet, 22, 281-285.
Manolio, T. A. (2010) Genomewide association studies and assessment of the risk of disease. The New England journal of medicine, 363, 166-176.
de Erausquin G. A., Zwir I., Harari O., Guerrero G., Florenzano N., Gonzaléz Alemán G., Calvo M., Padilla E., Bourdieu M., Duarte S. et al. (2012) A map function predictive of risk of psychosis obtained by concurrent genome wide association to dopaminergic deficits. Neuropsychopharmacology: official publication of the American College of Neuropsychopharmacology, 36. (Supplement 1 s) American College of Neuropsychopharmacology (ACNP) 50th Annual Meeting: S1-S504
Pascual-Montano, A., Carmona-Saez, P., Chagoyen, M., Tirado, F., Carazo, J. M. and Pascual-Marqui, R. D. (2006) bioNMF: a versatile tool for non-negative matrix factorization in biology. BMC Bioinformatics, 7, 366.
Cheng, Y. and Church, G. M. (2000) Biclustering of expression data. Proc Int Conf Intell Syst Mol Biol, 8, 93-103.
Yang, J., Wang, K., Wang, W. and Yu, P. (2003) Enhanced biclustering on expression data. IEEE Symposium on Biolnformatics and BioEngineering (BIBE '03), 1-7.
Hochreiter, S., Bodenhofer, U., Heusel, M., Mayr, A., Mitterecker, A., Kasim, A., Khamiakova, T., Van Sanden, S., Lin, D., Talloen, W. et al. (2010) FABIA: factor analysis for bicluster acquisition. Bioinformatics, 26, 1520-1527.
Beer, M. A. and Tavazoie, S. (2004) Predicting gene expression from sequence. Cell, 117, 185-198.
Mitchell, T. M. (1997) Machine learning. McGraw-Hill, New York.
Purcell, S., Neale, B., Todd-Brown, K., Thomas, L., Ferreira, M. A., Bender, D., Mailer, J., Sklar, P., de Bakker, P. I., Daly, M. J. et al. (2007) PLINK: a tool set for whole-genome association and population-based linkage analyses. American journal of human genetics, 81, 559-575.
Shi, J., Levinson, D. F., Duan, J., Sanders, A. R., Zheng, Y., Pe'er, I., Dudbridge, F., Holmans, P. A., Whittemore, A. S., Mowry, B. J. et al. (2009) Common variants on chromosome 6p22.1 are associated with schizophrenia. Nature, 460, 753-757.
Calvo de Padilla, M., Padilla, E., Gonzalez Aleman, G., Bourdieu, M., Guerrero, G., Strejilevich, S., Escobar, J. I., Svrakic, N., Cloninger, C. R. and de Erausquin, G. A. (2006) Temperament traits associated with risk of schizophrenia in an indigenous population of Argentina. Schizophrenia research, 83, 299-302.
Johnson, R. C., Nelson, G. W., Troyer, J. L., Lautenberger, J. A., Kessing, B. D., Winkler, C. A. and O'Brien, S. J. (2010) Accounting for multiple comparisons in a genome-wide association study (GWAS). BMC Genomics, 11, 724.
Mejia-Roa, E., Carmona-Saez, P., Nogales, R., Vicente, C., Vazquez, M., Yang, X. Y., Garcia, C., Tirado, F. and Pascual-Montano, A. (2008) bioNMF: a web-based tool for nonnegative matrix factorization in biology. Nucleic Acids Res, 36, W523-528.
Harari, O., Park, S. Y., Huang, H., Groisman, E. A. and Zwir, I. (2010) Defining the plasticity of transcription factor binding sites by Deconstructing DNA consensus sequences: the PhoP-binding sites among gamma/enterobacteria. PLoS Comput Biol, 6, e1000862.
Bezdek, J. C., Pal, S. K. and IEEE Neural Networks Council. (1992) Fuzzy models for pattern recognition: methods that search for structures in data. IEEE Press, New York.
Romero-Zaliz, R., C. Rubio, R., Cordón, O., Cobb, P., Herrera, F. and Zwir, I. (2008) A multi-objective evolutionary conceptual clustering methodology for gene annotation within structural databases: a case of study on the gene ontology database. IEEE Transactions on Evolutionary Computation, 12:6, 679-701.
Huang da, W., Sherman, B. T. and Lempicki, R. A. (2009) Systematic and integrative analysis of large gene lists using DAVID bioinformatics resources. Nature protocols, 4, 44-57.
Safran, M., Solomon, I., Shmueli, O., Lapidot, M., Shen-Orr, S., Adato, A., Ben-Dor, U., Esterman, N., Rosen, N., Peter, I. et al. (2002) GeneCards 2002: towards a complete, object-oriented, human gene compendium. Bioinformatics, 18, 1542-1543.
Bowers, P. M., Pellegrini, M., Thompson, M. J., Fierro, J., Yeates, T. O. and Eisenberg, D. (2004) Prolinks: a database of protein functional linkages derived from coevolution. Genome Biol, 5, R35.
Ruprecht-Dorfler, P., Berg, D., Tucha, O., Benz, P., Meier-Meitinger, M., Alders, G. L., Lange, K. W. and Becker, G. (2003) Echogenicity of the substantia nigra in relatives of patients with sporadic Parkinson's disease. Neuroimage, 18, 416-422.
Sedo, M. A. and DeCristoforo, L. (2001) All-language Verbal Tests Free from Linguistic Barriers. Revista Española De Neuropsicologia, 3, 68-82.
Kessels, R. P., van Zandvoort, M. J., Postma, A., Kappelle, L. J. and de Haan, E. H. (2000) The Corsi Block-Tapping Task: standardization and normative data. Applied neuropsychology, 7, 252-258.
Christensen, A. L. (1990) Luria's Neuropsychological Investigation. Manual and Test Material. 4th ed. New York: Spectrum Publications Inc.

1. A method of displaying the risk surface of a disease comprising:
providing a study database comprising numeric study data about a plurality of subjects in a study of said disease;
providing a phenomic database comprising phenotype data about a plurality of phenotype features of said plurality of subjects in said study of said disease;
identifying in said phenomic database a first bicluster set comprising plurality of phenotype biclusters in said received phenomic database;
identifying in said study database a second bicluster set comprising plurality of study data biclusters in said study database;
discovering a plurality of phenotype-study data relations between said first bicluster set and said second bicluster;
organizing said discovered plurality of phenotype-study data relations into a plurality of partitions;
organizing said plurality of discovered phenotype-study data relations in each partition in said plurality of partitions into one or more topological networks;
ranking the predictive utility of each one of said phenotype features;
generating a risk surface for said disease using said phenotype as an x-dimension, said study data as a y-dimension, and a calculated risk dimension based upon said predictive utility of each one of said phenotype features as a z-dimension, each one of said calculated risk dimensions being a point on said generated risk surface; and
displaying said generated risk surface to a user.

2. The method as claimed in claim 1, wherein said disease is a mental illness.

3. The method as claimed in claim 2, wherein said mental illness is schizophrenia.

4. A method of displaying the risk surface of a mental illness comprising:
providing a genomic database comprising numeric genotype data about a plurality of subjects in a study of said mental illness;
providing a phenomic database comprising phenotype data about a plurality of phenotype features of said plurality of subjects in said study of said mental illness;
receiving, by a computer server over a data communications network, a copy of said genomic database and a copy of said phenomic database;
said computer server identifying in said received phenomic database a first bicluster set, said first bicluster set comprising plurality of phenotype biclusters in said received phenomic database, said identification using a factorization algorithm;
said computer server identifying in said received genomic database a second bicluster set, said second bicluster set comprising plurality of genotype biclusters in said received genomic database, said identification using said factorization algorithm,
said computer server discovering a plurality of phenotype-genotype relations between said first bicluster set and said second bicluster set by calculating the pairwise probability of intersection between said first bicluster set and said second bicluster based at least in part upon the calculation of a R_{i,j} distribution statistic;
after said calculating step, said computer server organizing said discovered plurality of phenotype-genotype relations into a plurality of partitions by:
calculating the distance matrix among all phenotype-genotype relations in said discovered plurality of phenotype-genotype relations, said distance matrix being calculated based at least in part upon the calculation of a R_{i,j} distribution statistic; and
clustering said discovered plurality of phenotype-genotype relations based at least in part upon said calculated distance matrix, each one of said clusters being a partition in said plurality of partitions;
said computer server organizing said plurality of partitions, said organizing comprising, for each partition in said plurality of partitions:
optimizing said each partition, said optimizing comprising, for each phenotype-genotype relation in said discovered plurality of phenotype-genotype relations in said each partition, removing said each phenotype-genotype relation from said each partition if said each phenotype-genotype relation is redundant, said redundancy of said each phenotype-genotype relation being based upon said computer server determining whether a R_{i,j} distribution statistic calculated for said each phenotype-genotype relation is below a predefined threshold; and
after said optimizing step, organizing the remaining plurality of discovered phenotype-genotype relations in said each partition into one or more topological networks;
after said organizing step, said computer server ranking the predictive utility of said phenotype features, said ranking comprising, for each optimized partition in said plurality of partitions:
for each remaining relationship in said plurality of discovered phenotype-genotype relations in said each optimized partition:
labeling each subject in said each remaining relationship with one of two categorical class labels for said each relationship;
labeling each subject not in said each remaining relationship with a second of said two categorical class labels for said each relationship;
calculating a first decision tree ranking said feature utility, said first decision tree based at least in part on said phenotype database; and
calculating a second decision tree ranking said feature utility, said second decision tree based at least in part on said genotype database;
said computer server generating a visualization of the risk surface of said mental illness, said generation comprising, for each optimized relation in each partition in said plurality of optimized partitions:
forming a 3-tuple for said each relation, said formed 3-tuple comprising:
a phenotype dimension;
a genotype dimension; and
a risk dimension calculated at least in part from the weighted average of the epidemiological risks of all subjects in said each relation;
said computer server generating a computer-displayable image, said computer-displayable image comprising data which, when displayed by a computer, displays a projection of a three-dimensional graph projected on a two-dimensional plane, said three-dimensional graph comprising:
an x-axis corresponding to said phenotype dimension;
a y-axis corresponding to said risk-dimension; and
a surface generated from said formed 3-tuples and plotted on said graph such that for each of said formed 3-tuples, said risk dimension is a point on said surface; and
displaying said generated computer-displayable image to a user.

5. The method as claimed in claim 4, wherein said mental illness is schizophrenia.

6. The method as claimed in claim 4, wherein said factorization algorithm is a non-negative matrix factorization (“NFM”) method.

7. The method as claimed in claim 6, wherein said non-negative matrix factorization method is selected from the group consisting of the bioNFM method and the fuzzy NFM (“FNMF”) method.

8. The method as claimed in claim 4, wherein said factorization algorithm is selected from the group consisting of: the Cheng and Church method; the FABIA method; and, the FLOC method.

9. The method as claimed in claim 4, wherein all Ri,j distribution statistics (“PI_{hyp}”) are calculated using the equation
$${PI}_{hyp} ( {P}_{i} , {G}_{j} ) = 1 - {\sum }_{q = 0}^{p - 1} ( \begin{matrix}h \\ q\end{matrix} ) ( \begin{matrix}g - h \\ n - q\end{matrix} ) / ( \begin{matrix}g \\ h\end{matrix} ) \begin{matrix}h = \vert {P}_{i} \vert \\ n = \vert {G}_{j} \vert \\ p = {P}_{i} ⋂ {G}_{j}\end{matrix}$$
wherein p observations belong to a set Pᵢ of size h, and said p observations also belong to a set Gⱼ of size n; and
wherein g is the total number of observations.

10. The method as claimed in claim 4, wherein, in said organizing said plurality of partitions, after said optimizing step, said organizing the remaining plurality of discovered phenotype-genotype relations in said each partition into one or more topological networks is performed by said computer server using a statistical method for comparing similarity or diversity of sample sets.

11. The method as claimed in claim 10, wherein said statistical method for comparing similarity or diversity of sample sets uses a Jaccard similarity coefficient.

12. The method as claimed in claim 4, where said step of said computer server identifying in said received phenomic database a first bicluster set, said first bicluster set comprising plurality of phenotype biclusters in said received phenomic database, said identification using a factorization algorithm is performed independently of said step of said computer server identifying in said received genomic database a second bicluster set, said second bicluster set comprising plurality of genotype biclusters in said received genomic database, said identification using said factorization algorithm.

13. The method of claim 4, wherein said computer server limits the number of biclusters in said first bicluster set to a quantity no greater than the square root of the number of subjects represented in said phenomic database.

14. The method of claim 4, wherein said computer server limits the number of biclusters in said second bicluster set to a quantity no greater than the square root of the number of subjects represented in said genomic database.

15. The method of claim 4, wherein said computer server comprises a web server.

16. The method of claim 15, further comprising:
before said displaying step, said web server causes said generated computer-displayable image to be transmitted over said data communication network to a client computer; and
said displaying said generated computer-displayable image to a user comprises said client computer displaying said received generated computer-displayable image to a user of said client computer.

17. The method as claimed in claim 4, said method further comprising:
said computer server analyzing the statistical significance of at least some of said discovered relations to said mental illness, said analyzing comprising, for each optimized relation in each partition in said plurality of optimized partitions:
supervising said relation;
after said supervising step, said computer server performing an association test on said each optimized relation.

18. The method as claimed in claim 17, wherein said association test is a statistical regression test.

19. The method as claimed in claim 18, wherein said statistical regression test is a kernel-machine regression test.

20. The method as claimed in claim 19, wherein said kernel in said kernel-machine regression test is an identity-by-state kernel.
